(19) United States
(12) Patent Application Publication
(10) Pub. No.: US 2026/0077552 A1
(43) Pub. Date: Mar. 19, 2026

(54) SHAPED OBJECT PRODUCING METHOD AND SHAPED OBJECT PRODUCING APPARATUS

(71) Applicant: MIMAKI ENGINEERING CO., LTD., Nagano (JP)

(72) Inventor: Kenta Hongo, Nagano (JP)

(73) Assignee: MIMAKI ENGINEERING CO., LTD., Nagano (JP)

(21) Appl. No.: 19/108,424

(22) PCT Filed: Aug. 23, 2023
(86) PCT No.: PCT/JP2023/030368

§ 371 Date: Mar. 3, 2025

(30) Foreign Application Priority Data
Sep. 26, 2022 (JP) 2022-152424
Sep. 26, 2022 (JP) 2022-152425
Sep. 26, 2022 (JP) 2022-152427

(51) Int. Cl. B29C 64/112; B29C 64/129; B29C 64/209; B33Y 10/00; B33Y 30/00; B33Y 70/10

(52) U.S. Cl. CPC B29C 64/112; B29C 64/129; B29C 64/209; B33Y 10/00; B33Y 30/00; B33Y 70/10

(57) ABSTRACT

To reduce labor and cost in producing a shaped object. A method for producing a shaped object 7 to produce the three-dimensional shaped object 7 includes an ejecting step of ejecting ink from a head unit 2 to a liquid 6 stored in a liquid storage unit 5, and a curing step of curing the ink ejected to the liquid 6 by an ultraviolet curing unit 4.

### CROSS-REFERENCE TO RELATED APPLICATION

This application is a 371 application of the International PCT application serial no. PCT/JP2023/030368, filed on Aug. 23, 2023, which claims the priority benefits of Japan Patent Application No. 2022-152424, filed on Sep. 26, 2022, Japan Patent Application No. 2022-152425, filed on Sep. 26, 2022, and Japan Patent Application No. 2022-152427, filed on Sep. 26, 2022. The entirety of each of the above-mentioned patent applications is hereby incorporated by reference herein and made a part of this specification.

### TECHNICAL FIELD

The present invention relates to a shaped object producing method and a shaped object producing apparatus.

### DESCRIPTION OF THE RELATED ART

Patent Document 1 discloses a shaped object producing method for shaping a shaped object by layering a model material and a support material on a shaping table. In the plurality of layers formed of the model material, if there is a portion in which the upper layer side overhangs the lower layer side, it is easily influenced by gravity. In Patent Document 1, the overhang portion is supported by a support material.

Patent Document 2 discloses a method for removing a support material from a shaped object shaped by a 3D printer using a support material removing liquid.

### CITATION LIST

### Patent Documents

Patent Document 1: Japanese Patent Application Laid-Open No. 2021-146641

Patent Document 2: Japanese Patent Application Laid-Open No. 2018-83869

### SUMMARY OF THE INVENTION

### Problems to be Solved by the Invention

In the production of the shaped object, the time required for removing the support material is a loss. The waste liquid from which the support material has been removed requires industrial waste treatment, which takes time and cost.

Therefore, it is required to reduce labor and cost in producing the shaped object.

### MEANS FOR SOLVING THE PROBLEM

According to the present invention, there is provided a shaped object producing method for shaping a three-dimensional shaped object, including:
an ejecting step of ejecting ink to a liquid stored in a liquid storage unit; and
a curing step of curing the ink ejected to the liquid.

According to the present invention, it is possible to shape a three-dimensional shaped object without using a support material. Therefore, in the production of the shaped object, labor and cost related to the removing of the support material and the processing of the waste liquid from which the support material has been removed are reduced. In addition, the influence of gravity applied to the overhang portion of the model material can be reduced. Furthermore, since the surface of the shaped object is not influenced by the support material, the surface quality and the shaping accuracy of the shaped object are improved.

The shaped object producing method according to one aspect of the present invention, including:
a laminating step of laminating an ink layer in the liquid by repeating the ejecting step and the curing step.

According to the present invention, buoyancy acts on the portion of the upper ink layer that overhangs the lower ink layer. Thus, the influence of gravity on the overhang portion of the model material can be reduced without using the support material.

The shaped object producing method according to one aspect of the present invention, including:
a discharging step of discharging a liquid of the same volume as the ink layer whenever the ink layer is formed.

According to the present invention, since the distance of the ink until reaching the liquid can be kept constant, the landing accuracy of the ink on the liquid can be maintained.

The shaped object producing method according to one aspect of the present invention, including:
a supplying step of supplying the liquid having a height equal to a thickness of the ink layer whenever the ink layer is formed.

According to the present invention, since it is possible to omit the work of storing the liquid in the liquid storage unit in advance, it is possible to reduce the set-up work.

In the shaped object producing method according to one aspect of the present invention, the ink is ultraviolet curable ink.

According to the present invention, since the ink can be quickly cured, the time required to produce the shaped object can be shortened.

In the shaped object producing method according to one aspect of the present invention, the ink contains a material serving as a main agent, the liquid contains a material serving as a curing agent, and the ink is cured by mixing the liquid with the ink.

According to the present invention, various performances can be added to the shaped object by changing the combination of the material to be the main agent and the material to be the curing agent.

In the shaped object producing method according to one aspect of the present invention, the ink contains a metal catalyst component, and the liquid contains a peroxide component.

According to the present invention, a shaped object formed of an acrylic resin having high transparency can be produced.

In the shaped object producing method according to one aspect of the present invention, the ink is an epoxy resin, and the liquid is an amine curing agent.

According to the present invention, a shaped object formed of an epoxy-based resin having high corrosion resistance and scratch resistance can be produced.

In the shaped object producing method according to one aspect of the present invention, the ink contains a platinum catalyst component, and the liquid is a crosslinking agent having a hydrosilyl group.

According to the present invention, it is possible to produce a shaped object formed of a silicone-based resin having high safety to the human body.

In the shaped object producing method according to one aspect of the present invention, the ink contains a photoinitiator, the liquid contains a reactive group, and the ink mixed with the liquid is irradiated with ultraviolet light to cure the ink.

According to the present invention, since the ink can be quickly cured, the time required to produce the shaped object can be shortened.

In the shaped object producing method according to one aspect of the present invention, the ink is a thermosetting ink.

According to the present invention, a shaped object having high heat resistance can be produced.

In the shaped object producing method according to one aspect of the present invention, the ink is a thermoplastic ink.

According to the present invention, since the thermoplastic ink has high viscosity, the ink can be stably ejected, and spreading of the ink in the liquid can be reduced.

In the shaped object producing method according to one aspect of the present invention, the method for ejecting the ink is an inkjet method.

According to the present invention, since the surface of the shaped object is not influenced by the support material, fine color expression and fine shaping expression, which are advantages of the inkjet method, can be utilized.

According to the present invention, there is provided a shaped object producing apparatus for shaping a three-dimensional shaped object, including: a liquid storage unit that holds a liquid; an ejecting unit that ejects ink to the liquid; and a curing unit that cures the ink ejected to the liquid.

According to the present invention, the influence of gravity applied to the overhang portion of the model material can be reduced without using the support material. Furthermore, since the surface of the shaped object is not influenced by the support material, the surface quality and the shaping accuracy of the shaped object are improved.

The shaped object producing apparatus according to one aspect of the present invention, including:
a recovery unit that recovers the liquid overflowing from the liquid storage unit.

According to the present invention, since the distance between the liquid level of the liquid and the ejecting unit can be kept constant, the landing accuracy of the ink on the liquid can be maintained.

In the shaped object producing apparatus according to one aspect of the present invention, the liquid storage unit has a recess in which an upper surface of a table provided below the ejecting unit is opened, and the liquid is stored in the recess.

According to the present invention, since the recess is provided directly on the table, the position of the liquid storage unit is fixed. Since it is not necessary to position the liquid storage unit, the set-up work can be reduced.

The shaped object producing apparatus according to one aspect of the present invention, including:
a vibration suppression mechanism that suppresses vibration of the liquid storage unit.

According to the present invention, the shift of the landing position of the ink due to the vibration of the liquid in the liquid storage unit can be reduced. Furthermore, vibration of the shaped object can also be reduced.

In the shaped object producing apparatus according to one aspect of the present invention, the ejecting unit is an inkjet head.

According to the present invention, fine color expression and fine shaping can be performed by ejecting the ink from the inkjet head.

According to the present invention, there is provided a shaped object producing method for shaping a three-dimensional shaped object, including:
an ejecting step of ejecting ink to a liquid stored in a liquid storage unit; and
a curing step of curing the ink ejected to the liquid,
wherein the ink is formed of a composition having a specific gravity before curing lighter than that of the liquid and a specific gravity after curing heavier than that of the liquid.

According to the present invention, the cured ink sinks in the liquid by its own weight. Therefore, the ink to be ejected next lands on the same plane as the liquid level of the liquid. As a result, the positions of the overhang portion and the overlap portion in the laminating direction can be aligned in each layer of the model material without using the support material.

In the shaped object producing method according to one aspect of the present invention, the ink before curing has a viscosity of 15 mPa·s or more and 30 mPa·s or less.

According to the present invention, the ejected ink can be reduced from spreading on the liquid level of the liquid.

In the shaped object producing method according to one aspect of the present invention, the liquid contains a material exhibiting thixotropy.

According to the present invention, the position of the ink that landed on the liquid level can be reduced from shifting.

The shaped object producing method according to one aspect of the present invention, including:
a base forming step of forming a base on which the shaped object is placed with the ink prior to the shaping of the shaped object.

According to the present invention, the ink layers can be laminated while the horizontal is ensured.

In the shaped object producing method according to one aspect of the present invention, the method for ejecting the ink is an inkjet method.

According to the present invention, since the surface of the shaped object is not influenced by the support material, fine color expression and fine shaping expression, which are advantages of the inkjet method, can be utilized.

According to the present invention, there is provided a shaped object producing apparatus for shaping a three-dimensional shaped object, including:
a liquid storage unit that holds a liquid;
an ejecting unit that ejects ink to the liquid; and
a curing unit that cures the ink ejected to the liquid,
wherein the ink is formed of a composition having a specific gravity before curing lighter than that of the liquid and a specific gravity after curing heavier than that of the liquid.

According to the present invention, the cured ink sinks in the liquid by its own weight. Therefore, the ink to be ejected next lands on the same plane as the liquid level of the liquid over the entire surface. As a result, the positions of the overhang portion and the overlap portion in the laminating direction can be aligned in each layer of the model material without using the support material.

In the shaped object producing apparatus according to one aspect of the present invention, the ejecting unit is an inkjet head.

According to the present invention, fine color expression and fine shaping can be performed by ejecting the ink from the inkjet head.

According to the present invention, there is provided a shaped object producing method for laminating an ink layer by repeating an ejecting step of ejecting ink to a liquid stored in a liquid storage unit and a curing step of curing the ink ejected to the liquid to form the ink layer,
wherein the ejecting step includes an assisting step of forming a holding region of the ink ejected in the ejecting step, and the holding region holds the ink landed at a position away from the cured ink at the landing position.

According to the present invention, since the interval between the inks ejected to the plurality of regions can be reduced, the influence on the shaping quality of the shaped object can be suppressed.

In the shaped object producing method according to one aspect of the present invention, the holding region is an overhang region in the shaped object.

According to the present invention, the shaping accuracy of the overhang region is improved.

In the shaped object producing method according to one aspect of the present invention, the method for ejecting the ink is an inkjet method.

According to the present invention, since the surface of the shaped object is not influenced by the support material, fine color expression and fine shaping expression, which are advantages of the inkjet method, can be utilized.

In the shaped object producing method according to one aspect of the present invention, the holding region is connected to an inner peripheral surface of the liquid storage unit.

According to the present invention, the shaped object can be reduced from moving or falling in the liquid storage unit.

In the shaped object producing method according to one aspect of the present invention, the holding region is connected to the cured ink.

According to the present invention, since the variation in the shaping position of the holding region itself can be reduced, the variation in the interval between the inks ejected to the plurality of regions can be more suitably reduced.

In the shaped object producing method according to one aspect of the present invention, the assisting step is included in an ejecting step one time before the ejecting step of ejecting the ink to a position away from the cured ink.

According to the present invention, the ink ejected to a position away from the cured ink is held by being laminated in the holding region formed in the ejecting step one time before. Thus, the interval between the inks ejected to the plurality of regions can be reduced from varying.

In the shaped object producing method according to one aspect of the present invention, the assisting step is included in an ejecting step of ejecting the ink to a position away from the cured ink.

According to the present invention, the ink is held at a position away from the cured ink by being integrally formed with the holding region. Thus, the interval between the inks ejected to the plurality of regions can be reduced from varying.

According to the present invention, there is provided a shaped object producing apparatus, including:
a liquid storage unit that stores liquid; and
a control unit that controls ejecting of ink from an ejecting unit to the liquid and curing of the ejected ink by a curing unit,
wherein the control unit repeats the ejecting of the ink to the liquid and the curing of the ink ejected to the liquid to shape a shaped object that is a laminate of cured inks, and
wherein a holding region that holds the ink landed at a position away from the cured ink at the landing position is formed by curing the ink ejected from the ejecting unit.

According to the present invention, since the interval between the inks ejected to the plurality of regions can be reduced, the influence on the shaping quality of the shaped object can be suppressed.

In the shaped object producing apparatus according to one aspect of the present invention, the control unit forms the holding region by the connection to an inner peripheral surface of the liquid storage unit.

According to the present invention, the shaped object can be reduced from moving or falling in the liquid storage unit.

In the shaped object producing apparatus according to one aspect of the present invention, the control unit forms the holding region by the connection to the cured ink.

According to the present invention, since the variation in the shaping position of the holding region itself can be reduced, the variation in the interval between the inks ejected to the plurality of regions can be more suitably reduced.

In the shaped object producing apparatus according to one aspect of the present invention, the ejecting unit is an inkjet head.

According to the present invention, fine color expression and fine shaping can be performed by ejecting the ink from the inkjet head.

### Advantageous Effects of the Invention

According to the present invention, labor and cost can be reduced in the shaping of the shaped object.

### BRIEF DESCRIPTION OF DRAWINGS

FIGS. 1A and 1B are views illustrating a shaped object producing apparatus.

FIG. 2 is a view illustrating a liquid storage unit.

FIG. 3 is a view illustrating a liquid storage unit.

FIGS. 4A and 4B are views illustrating slice data of a shaped object.

FIGS. 5A and 5B are views illustrating a shaped object producing method.

FIGS. 6A and 6B are views illustrating a shaped object producing method.

FIGS. 7A and 7B are views illustrating a shaped object producing method.

FIGS. 8A, 8B, and 8C are views illustrating a shaped object producing apparatus according to Modified Example 1.

FIG. 9 is a view illustrating a shaped object producing apparatus according to Modified Example 2.

FIG. 10 is a view illustrating a shaped object producing apparatus according to Modified Example 3.

FIG. 11 is a view illustrating a shaped object producing apparatus according to Modified Example 4.

FIG. 12 is a view illustrating slice data of a shaped object according to Modified Example 4.

FIGS. 13A, 13B, and 13C are views illustrating a shaped object producing method according to Modified Example 4.

FIGS. 14A and 14B are views illustrating a shaped object producing method according to Modified Example 4.

FIGS. 15A, 15B, and 15C are views illustrating a shaped object producing method according to Modified Example 5.

FIG. 16 is a view illustrating a shaped object according to Modified Example 6.

FIG. 17 is a view illustrating slice data of a shaped object according to Modified Example 6.

FIGS. 18A and 18B are views illustrating a shaped object producing method according to Modified Example 6.

FIG. 19 is a view illustrating a shaped object producing method according to Modified Example 7.

FIG. 20 is a view illustrating a shaped object producing method according to Modified Example 8.

### DESCRIPTION OF EMBODIMENTS

Hereinafter, a producing apparatus 1 for producing a three-dimensional shaped object 7 by an inkjet method will be described as an example.

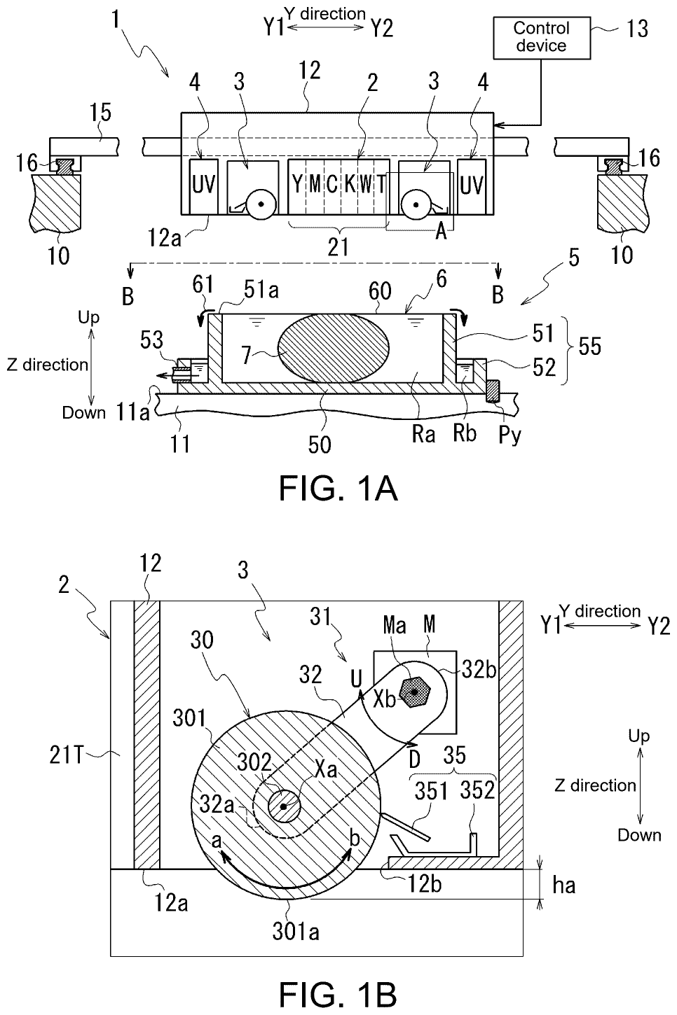

FIGS. 1A and 1B are views illustrating the producing apparatus 1. FIG. 1A is a schematic configuration diagram of the producing apparatus 1. FIG. 1B is a view illustrating a roller unit 3. FIG. 1B is an enlarged view of region A in FIG. 1A.

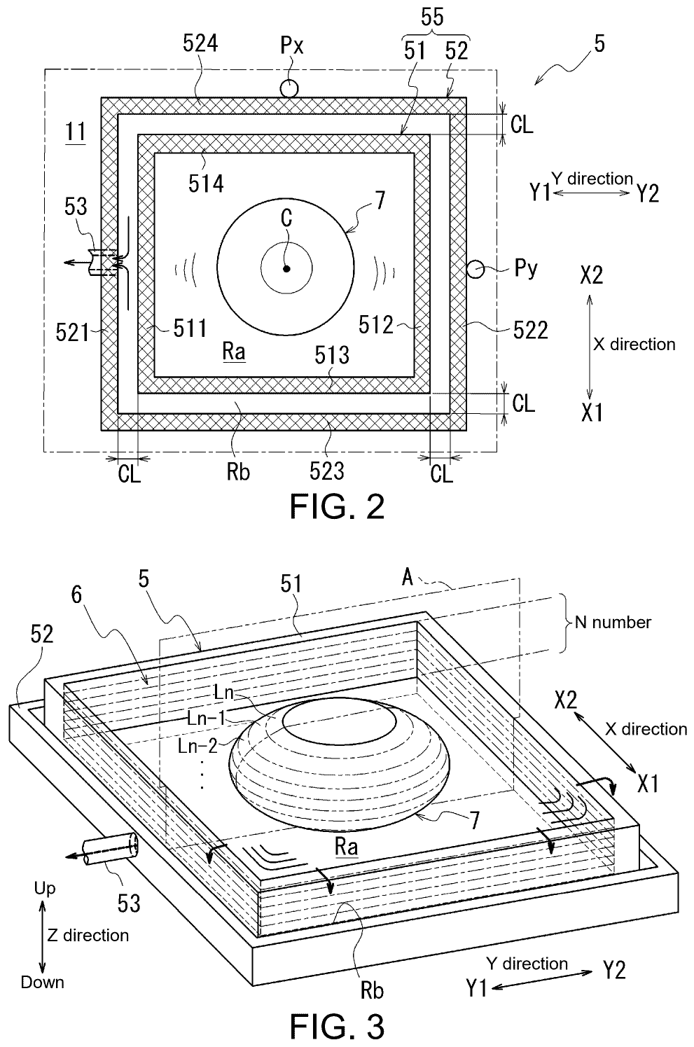

FIG. 2 is a view illustrating a liquid storage unit 5. FIG. 2 is a view taken along line B-B of FIG. 1A.

FIG. 3 is a perspective view illustrating the liquid storage unit 5.

In the following description, a “Y direction” means a main scanning direction of the producing apparatus 1. The main scanning direction is a left and right direction when the producing apparatus 1 is viewed from the front. The “X direction” means a sub-scanning direction. The sub-scanning direction is a direction orthogonal to the main scanning direction, and is a direction from the front side to the back side of the producing apparatus 1. The “Z direction” means a vertical direction when the producing apparatus 1 is placed on a horizontal plane. In addition, “Y1 side” means one side (left side in FIG. 1A) in the Y direction when the producing apparatus 1 is viewed from the front, and“ Y2 side ” means the other side (right side in FIG. 1A). The “X1 side” means the front side (lower side in FIG. 2) of the producing apparatus 1, and the “X2 side” means the back side (upper side in FIG. 2).

As illustrated in FIG. 1A, the producing apparatus 1 includes a table 11, a carriage 12 which is disposed movably in the Y direction above the table 11, and a control device 13 which controls the producing apparatus 1. The liquid storage unit 5 used when producing the shaped object 7 is placed on the table 11.

A guide rail 15 disposed along the Y direction is provided above the table 11. The guide rail 15 guides the movement of the carriage 12 in the Y direction.

Both ends of the guide rail 15 in the Y direction are supported by guide rails 16 and 16. The guide rails 16 and 16 are arranged along the X direction. The guide rails 16 and 16 are fixed to body frames 10 and 10 of the producing apparatus 1, respectively. The guide rails 16 and 16 guide the movement of the guide rail 15 and the carriage 12 in the X direction.

The producing apparatus 1 includes a moving mechanism that moves the carriage 12 in the Y direction. Although not illustrated, the moving mechanism includes a belt provided in a direction along the Y direction, a driving pulley and a driven pulley around which the belt is wound, and a motor which rotates the driving pulley. The carriage 12 is fixed to the belt. The carriage 12 moves in the Y direction along the guide rail 15 by driving the motor to rotate the belt on the basis of a command from the control device 13.

In addition, the producing apparatus 1 includes a feeding mechanism that moves the guide rail 15 in the X direction. Although not illustrated, the feeding mechanism includes a belt provided in a direction along the X direction, a driving pulley and a driven pulley around which a belt is wound, and a motor which rotates the driving pulley. The guide rail 15 is fixed to the belt. The guide rail 15 moves in the X direction together with the carriage 12 along the guide rails 16 and 16 by driving the motor to rotate the belt on the basis of a command from the control device 13.

A head unit 2 (ejecting unit), the roller unit 3, and an ultraviolet irradiating unit 4 (curing unit) are mounted on the carriage 12.

The head unit 2 is an inkjet head that ejects ink. In this embodiment, a case of using an ultraviolet curable ink will be exemplified. The roller unit 3 flattens the ink ejected from the head unit 2. The ultraviolet irradiating unit 4 irradiates the ink with ultraviolet UV to cure the ink.

The roller unit 3 and the ultraviolet irradiating unit 4 are provided on one side and the other side of the head unit 2 in the Y direction, respectively. The roller units 3 and 3 are arranged closer to the head unit 2 than the ultraviolet irradiating units 4 and 4 in the Y direction.

The head unit 2 includes coloring heads 21Y, 21M, 21C, and 21K that eject yellow (Y), magenta (M), cyan (C), and black (K) inks, a white head 21W that ejects white (W) ink, and a clear head 21T that ejects transparent ink containing no coloring component. The carriage 12 is provided with these heads 21 (21Y, 21M, 21C, 21K, 21W, 21T), roller units 3 and 3, and ultraviolet irradiating units 4 and 4 arranged in the Y direction. In the drawings, only “Y, M, C, K, W, T” at the end is illustrated for reference numerals 21Y, 21M, 21C, 21K, 21W, and 21T.

In this embodiment, the viscosity of the ink is set to 15 mPa·s or more and 30 mPa·s or less at a temperature of the ink of 45° C. The specific gravity of the ink with a liquid 6 to be described later is preferably set to 1.04 g/cm³ or more and 1.12 g/cm³ or less before curing, and is preferably set to 1.12 g/cm³ or more and 1.20 g/cm³ or less after curing.

Although not illustrated, each nozzle surface of the head 21 (21Y, 21M, 21C, 21K, 21W, 21T) is exposed to the outside of the carriage 12 from a bottom surface 12a of the carriage 12. Each nozzle surface is provided with a plurality of nozzle holes along the X direction. The ink of each color is ejected from the nozzle hole toward the table 11.

The ultraviolet irradiating unit 4 irradiates the ink ejected from the head unit 2 with ultraviolet UV. As a light source of ultraviolet UV, a metal halide lamp or an ultraviolet LED is used.

As illustrated in FIG. 1B, the roller unit 3 includes a roller portion 30, an adjustment portion 31 (adjusting mechanism), and a cleaning portion 35. The roller portion 30 levels and flattens the ejected ink. The adjustment portion 31 adjusts the contact pressure between the roller portion 30 and the ink. The cleaning portion 35 removes the ink attached to the roller portion 30.

The roller portion 30 includes a shaft 302 that is provided in a direction along the X direction, and a roller 301 that is externally fitted to the shaft 302 and rotates integrally with the shaft 302. An outer peripheral surface 301a of the roller 301 is parallel to an axis Xa. In the outer peripheral surface 301a of the roller 301, a region below the axis Xa protrudes toward the table 11 from an opening 12b provided in the bottom surface 12a of the carriage 12. A motor (not illustrated) is connected to the shaft 302, and when the motor operates based on a command from the control device 13, the motor rotates about the axis Xa together with the roller 301 (the direction of the arrow a or the direction of the arrow b in the drawing).

The adjustment portion 31 includes a motor M fixed to a wall portion on the back side of the drawing of the carriage 12, and an arm portion 32 provided across the motor M and the shaft 302.

A drive shaft Ma of the motor M is provided in a direction along the X direction. When viewed from the shaft 302, the drive shaft Ma of the motor M is provided above the roller 301. When viewed from the shaft 302, the drive shaft Ma of the motor M is provided on the side opposite to the head unit 2.

The arm portion 32 is connected to the drive shaft Ma of the motor M on the other end 32b side so as to be relatively non-rotatable. The arm portion 32 supports the shaft 302 so as to be relatively rotatable on the one end 32a side.

The adjustment portion 31 drives the motor M on the basis of a command from the control device 13 while supporting the roller portion 30 on the one end 32a side of the arm portion 32, and rotates the arm unit 32 about an axis Xb (the direction of the arrow U or the direction of the arrow D in the drawing). Thus, a protrusion amount ha of the roller 301 from the bottom surface 12a of the carriage 12 is adjusted.

The cleaning portion 35 includes a wiper 351 and a tray 352. The wiper 351 and the tray 352 are provided in a direction along the radial direction of the axis Xa. The roller 301, the wiper 351, and the tray 352 are arranged in this order from the radially inner side to the radially outer side of the axis Xa.

The cleaning portion 35 removes the ink adhered to the outer peripheral surface 301a of the roller 301 with the wiper 351, and collects the removed ink with the tray 352. A drain hose (not illustrated) is connected to the tray 352. The ink collected by the tray 352 is discharged from the drain hose.

As illustrated in FIG. 1A, the liquid storage unit 5 is provided below the carriage 12. The liquid storage unit 5 is placed on the table 11. The liquid storage unit 5 is a tank body having an open upper portion, and is filled with the liquid 6. In the liquid storage unit 5, the shaped object 7 is immersed in the liquid 6.

As illustrated in FIG. 1A, the liquid storage unit 5 includes a bottom wall portion 50 in contact with an upper surface 11a of the table 11, and a peripheral wall portion 55 surrounding the outer periphery of the bottom wall portion 50. The peripheral wall portion 55 extends upward in the Z direction from the bottom wall portion 50.

As illustrated in FIG. 2, the peripheral wall portion 55 has a rectangular shape in plan view.

Specifically, the peripheral wall portion 55 includes a first peripheral wall portion 51 surrounding the shaped object 7 and a second peripheral wall portion 52 surrounding the first peripheral wall portion 51. In FIG. 2, the first peripheral wall portion 51 and the second peripheral wall portion 52 are cross-hatched for easy viewing.

The first peripheral wall portion 51 includes wall portions 511 and 512 provided in a direction along the X direction and wall portions 513 and 514 provided in a direction along the Y direction and connecting end portions of the wall portions 511 and 512.

The second peripheral wall portion 51 includes wall portions 521 and 522 provided in a direction along the X direction and wall portions 523 and 524 provided in a direction along the Y direction and connecting end portions of the wall portions 521 and 522. The wall portions 521 to 524 of the second peripheral wall portion 52 is provided in parallel with the wall portions 511 to 514 of the first peripheral wall portion 51 with a gap CL therebetween.

As illustrated in FIG. 1A, the liquid storage unit 5 has a space Ra inside the first peripheral wall portion 51 and a space Rb between the first peripheral wall portion 51 and the second peripheral wall portion 52. The liquid 6 is stored in the space Ra. The space Rb collects the liquid 6 overflowing from the space Ra.

As illustrated in FIGS. 2 and 3, a drain hose 53 penetrating the wall portion 521 in the Y direction is connected to the wall portion 521 of the second peripheral wall portion 52. The drain hose 53 communicates with the space Rb. The liquid 6 overflowing from the space Ra is collected in the space Rb and then discharged from the drain hose 53 to the outside. That is, the space Rb and the drain hose 53 constitute a recovery unit that recovers the liquid 6 overflowing from the space Ra.

As illustrated in FIG. 2, the table 11 is provided with positioning pins Px and Py. The positioning pins Px and Py protrude upward in the Z direction from the upper surface 11a of the table 11 (see FIG. 1A).

As illustrated in FIG. 2, in the liquid storage unit 5, the liquid storage unit 5 can be disposed at a predetermined position on the table 11 by bringing the wall portion 522 of the second peripheral wall portion 52 into contact with the positioning pin Py in the Y2 direction and bringing the wall portion 524 into contact with the positioning pin Px in

### The X2 Direction.

As a result, the space Ra of the liquid storage unit 5 is located in a preset ink ejection region (region where the shaped object 7 is formed) when viewed from the Z direction.

As illustrated in FIG. 3, the inside of the first peripheral wall portion 51 of the liquid storage unit 5 is filled with the liquid 6. As illustrated in FIG. 1A, the liquid level 60 of the liquid 6 is flush with the upper surface 51a of the first peripheral wall portion 51. In this state, the shaped object 7 is immersed in the liquid 6 in the space Ra inside the first peripheral wall portion 51.

It is preferable that the liquid 6 has a viscosity at which the shaped object 7 in the liquid 6 does not move in a short period of time such as immediately after landing of the ink, but finally moves (sinks) in the Z direction in order to laminate the ink layer.

Specifically, the viscosity of the liquid 6 is preferably more than 0 Pa·s and 100 Pa·s or less, and particularly preferably more than 0 Pa·s and 1 Pa·s or less.

Therefore, the liquid 6 according to this embodiment includes polyvinyl alcohol (PVA), borax, and water, and has a predetermined viscosity included in the above range. Further, the liquid 6 may be a mixture of water, flour, soybean flour, and starch, or a mixture of a resin material (monomer or oligomer) and a filler.

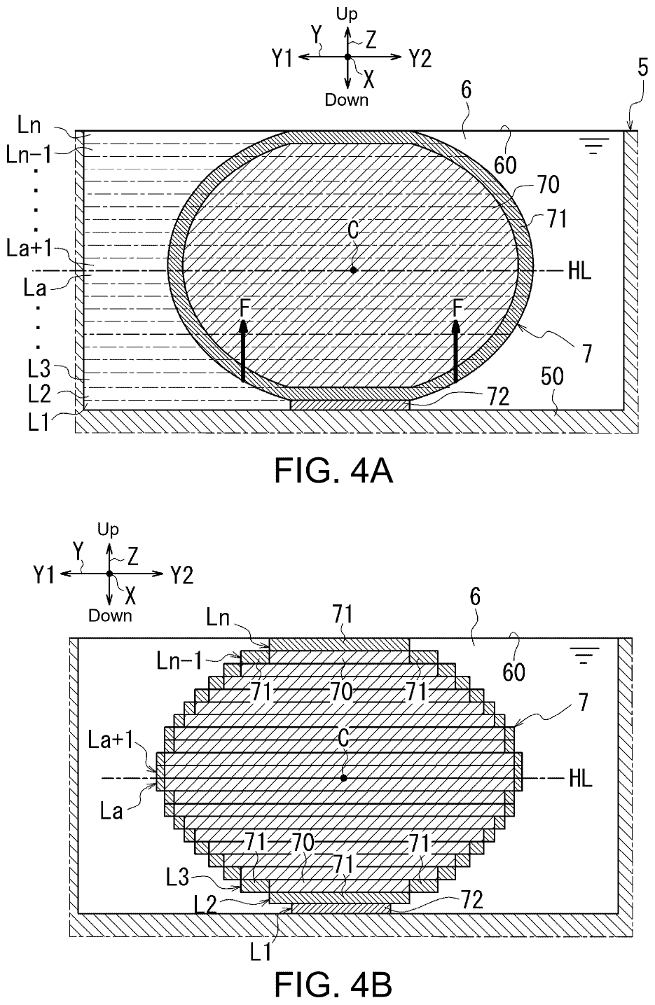

FIGS. 4A and 4B are views illustrating slice data of the shaped object 7. FIG. 4A is a schematic cross-sectional view of the shaped object 7 cut along a plane A along the Y direction of FIG. 3. FIG. 4B is three-dimensional data when the shaped object 7 is created by the producing apparatus 1, and is slice data corresponding to the cross section illustrated in FIG. 4a.

As illustrated in FIG. 4A, the shaped object 7 includes a solid portion 70 and a coloring portion 71 that covers the solid portion 70. Furthermore, an ejecting base 72 is interposed between the shaped object 7 and the bottom wall portion 50 of the liquid storage unit 5. The ejecting base 72 is a flat plate for uniformly applying buoyancy to the shaped object 7 in the middle of producing. The ejecting base 72 may be a part of the shaped object 7, or may be cut after producing the shaped object 7.

The solid portion 70 is a central region of the shaped object 7, and is formed with an outer shape corresponding to the shape of the shaped object 7. The solid portion 70 is formed of, for example, white (W) ink.

The coloring portion 71 and the ejecting base 72 are regions formed by curing of coloring ink such as yellow (Y), magenta (M), cyan (C), and black (K). The coloring portion 71 covers the entire surface of the solid portion 70. The coloring portion 71 contains inks such as Y (yellow), M (magenta), C (cyan), and K (black) at a predetermined ratio determined according to the color to be realized, and the color exhibited by the coloring portion 71 appears on the surface of the shaped object 7.

The ink used for the coloring portion 71 is not limited to the inks such as Y (yellow), M (magenta), C (cyan), and K (black) described above. The clear (T) ink and the white (W) ink may be included. Furthermore, R (red) ink, G (green) ink, and B (blue) ink may be included.

As illustrated in FIG. 4A, in the producing apparatus 1, the shaped object 7 is sliced (partitioned) at equal intervals in the Z direction, and N ink layers (L1 to Ln: n are arbitrary integers) are set. The shaped object 7 is created by sequentially laminating the ink layers from the ink layer L1 on the bottom wall portion 50 side of the liquid storage unit 5 to the ink layer Ln on the liquid level 60 side of the liquid 6.

As illustrated in FIG. 4B, the ejecting base 72 is formed on the ink layer L1. The coloring portion 71 is formed on the ink layer L2 and the ink layer Ln. The solid portion 70 and the coloring portion 71 are formed in the ink layers L3 to Ln-1.

As illustrated in FIG. 4A, the shaped object 7 according to this embodiment is formed to spread in the X direction and the Y direction from the lower side toward the upper side in the Z direction in the ink layers (L1 to La) in the region below the horizontal line HL passing through the center C of the shaped object 7 (for example, the ink layer L2 viewed from the ink layer L1 or the ink layer L3 viewed from the ink layer L2). Thus, the shaped object 7 has a portion in which the upper layer side overhangs the lower layer side. The shaped object 7 according to this embodiment reduces the influence of gravity without using the conventional support material by applying the buoyancy F of the liquid 6 to the overhang portion.

Hereinafter, a method for producing the shaped object 7 by the producing apparatus 1 will be described.

Hereinafter, as a method for producing the shaped object 7, a case of forming the ink layers L1 to L3 illustrated in FIG. 4B will be described as an example.

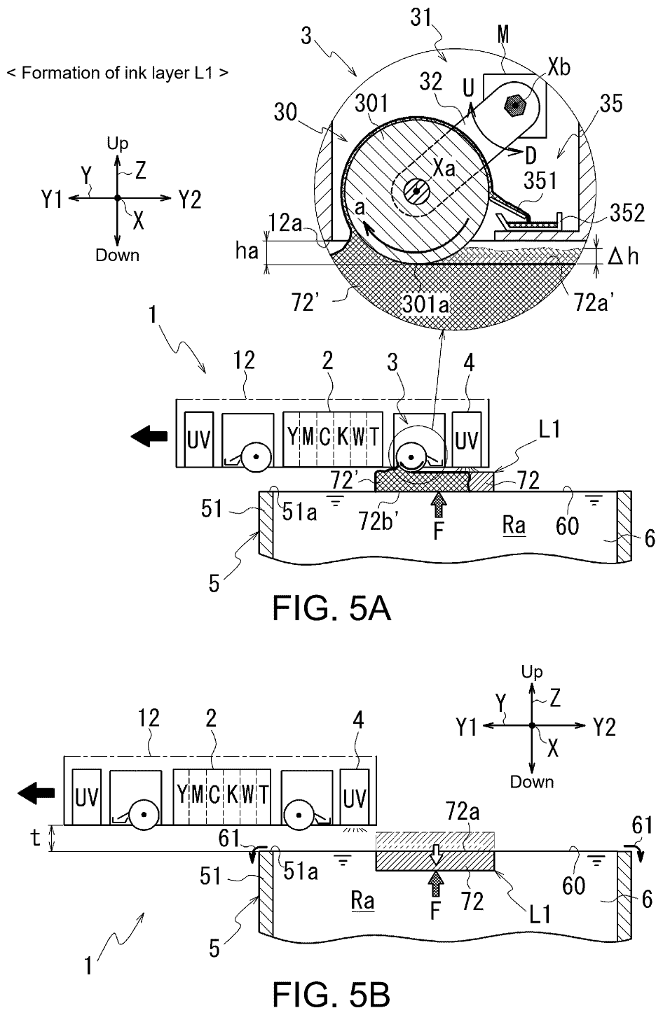

FIGS. 5 to 7 are views for sequentially illustrating formation of the ink layer L1 to the ink layer L3 based on the slice data illustrated in FIG. 4B. In FIGS. 5 to 7, in the ink layers L1 to L3, the uncured region is cross-hatched, and the cured region is hatched. Furthermore, the uncured region in each portion of the shaped object 7 is denoted with “′” attached to the reference numeral.

The ink layers are preferably laminated on a horizontal plane in order to uniformly apply buoyancy of the liquid 6. In this embodiment, in order to secure a horizontal plane, the ejecting base 72 is provided as the ink layer L1 which is the lowermost layer (see FIG. 4B). That is, the ejecting base 72 is formed prior to the shaping of the shaped object 7 (base forming step). In this embodiment, the area of the ejecting base 72 is made smaller than the area of the ink layer L2 in order to describe the overhang, but the area of the ejecting base 72 may be the same as or larger than the area of the ink layer L2.

### Formation of Ink Layer L1

FIGS. 5A and 5B are views illustrating formation of the ink layer L1. FIG. 5A is a view illustrating flattening of the ink by the roller unit 3. FIG. 5B is a view illustrating the cured ink layer L1.

As illustrated in FIG. 5A, the shaped object 7 is produced while the space Ra of the liquid storage unit 5 is filled with the liquid 6 in advance. The liquid level 60 of the liquid 6 is flush with the upper surface 51a of the first peripheral wall portion 51 of the liquid storage unit 5. The supply of the liquid 6 may be manually performed by an operator, or a supply unit 8 (see FIG. 11) to be described later may be used.

As illustrated in FIG. 5A, the producing apparatus 1 ejects ink from the head unit 2 toward the liquid 6 while moving the carriage 12 in the Y1 direction (the direction of the black arrow in the drawing) (ejecting step). The uncured ink lands on the liquid level 60 of the liquid 6.

As described above, the viscosity of the liquid 6 is set to be more than 0 Pa·s and 100 Pa·s or less. Specifically, the viscosity of the ink is set to 15 mPa·s or more and 30 mPa·s or less at a temperature of the ink of 45° C. The specific gravity of the ink and the liquid 6 is set to 1.04 g/cm³ or more and 1.12 g/cm³ or less before the ink is cured, and is set to 1.12 g/cm³ or more and 1.20 g/cm³ or less after the ink is cured.

Therefore, the ink that landed on the liquid level 60 is held at a predetermined landing position in the X and Y directions without diffusing on the liquid level 60. The uncured ink has a smaller specific gravity than the liquid 6. Therefore, the buoyancy F acts on a lower surface 72b′ of an ejecting base 72′ including the uncured ink from the liquid 6 (hatched arrow in the drawing). Therefore, the ejecting base 72′ floats on the liquid level 60.

Further, the producing apparatus 1 flattens the ejecting base 72′ with the roller unit 3 while moving the carriage 12 in the Y1 direction (flattening step).

Specifically, as illustrated in the enlarged region of FIG. 5A, the outer peripheral surface 301a is brought into contact with the ejecting base 72′ to scrape the upper portion of the ejecting base 72′ while rotating the roller 301 about the axis Xa. As a result, an upper surface 72a′ of the ejecting base 72′ after passage of the roller portion 30 becomes a horizontal surface along the X and Y directions.

In this embodiment, the rotation direction of the roller 301 is rotated so as to be a direction along the moving direction (Y1 direction) of the carriage 12 (the direction of the arrow a). As a result, the smoothness of the upper surface 72a′ of the ejecting base 72′ can be improved.

Furthermore, the rotation direction of the roller 301 may be rotated so as to be opposite to the moving direction (Y1 direction) of the carriage 12 (the direction of the arrow b; see FIG. 1B). In this case, mixing of the ink constituting the ejecting base 72′ is small.

Here, the ejecting base 72′ floating on the liquid level 60 may be pushed by contact with the roller 301, and may be displaced. Therefore, the contact pressure between the roller 301 and the ejecting base 72′ can be adjusted by operating the adjustment portion 31 to adjust the bite amount Δh of the roller 301 into the ejecting base 72′ in the Z direction.

Examples of the contact pressure include a method in which a sensor is provided in a motor that drives the roller portion 30, and a load torque applied to the motor is measured when the ink is scraped off by the roller 301.

For example, when the ejecting base 72′ moves on the liquid level 60 by the roller portion 30, it is conceivable to reduce the contact pressure to cope with the case. In this case, the bite amount Δh may be reduced. Specifically, the motor M of the adjustment portion 31 is driven to rotate the arm portion 32 upward (in the direction of the arrow U) about the axis Xb, so that the protrusion amount ha of the roller 301 from the bottom surface 12a of the carriage 12 is reduced. As a result, the bite amount Δh is reduced, and the ink can be scraped off while the contact pressure is lowered, so that the movement of the ejecting base 72′ on the liquid level 60 can be reduced.

Furthermore, the number of passes may be increased by the amount by which the bite amount Δh is reduced until the ejecting base 72′ reaches a predetermined thickness to scrape the ink. In this case, the arm portion 32 may be displaced little by little toward the lower side (in the direction of the arrow D) around the axis Xb for each pass.

On the other hand, when the viscosity of the liquid 6 is increased to make it difficult for the ejecting base 72′ to move on the liquid level 60, the bite amount Δh can be increased to increase the contact pressure. Specifically, the protrusion amount ha of the roller portion 30 from the bottom surface 12a of the carriage 12 increases by driving the motor M to rotate the arm portion 32 downward (in the direction of the arrow D) about the axis Xb. As a result, since the bite amount Δh increases, the time required for flattening the ejecting base 72′ can be shortened.

The ink scraped off by the roller 301 moves in the circumferential direction around the axis Xa in accordance with the rotation of the roller 301 in a state of being attached to the outer peripheral surface 301a. The wiper 351 of the cleaning portion 35 abuts on the outer peripheral surface 301a on the downstream side of the ejecting base 72′ in the circumferential direction around the axis Xa. Therefore, the ink adhered to the outer peripheral surface 301a of the roller 301 is separated from the roller 301 by the wiper 351 and then collected on the tray 352.

While moving the carriage 12 in the Y1 direction, the producing apparatus 1 irradiates the ejecting base 72′, which has been flattened, with ultraviolet rays UV from the ultraviolet irradiating unit 4 (curing step). Thus, the ejecting base 72 formed of the cured ink is formed as the ink layer L1.

The specific gravity of the cured ink is set to be larger than that of the liquid 6. Therefore, the cured ink sinks in the liquid 6.

Specifically, as illustrated in FIG. 5B, the ejecting base 72 after curing sinks downward in the Z direction by its own weight while the positions in the X and Y directions are held (white arrow in the drawing). In this case, the ejecting base 72 is balanced with the buoyancy F at a position where the upper surface 72a is flush (on the same plane) with the liquid level 60.

After the ejecting base 72 is formed, the carriage 12 may be moved in the Y2 direction, and the ejecting base 72 may be pushed into the liquid 6 by the roller unit 3 so that the upper surface 72a and the liquid level 60 are flush with each other.

As a result, it is possible to use the high-viscosity liquid 6 that is less likely to sink under its own weight of the ejecting base 72, and the ejecting base 72 is less likely to be displaced. Furthermore, since the liquid level 60 is also flattened, the accuracy of forming the next ink layer L2 is also improved.

Then, the liquid 61 overflows from the space Ra of the liquid storage unit 5 by the volume by which the ink layer L1 (ejecting base 72) sinks in the liquid 6. Accordingly, the liquid level 60 of the liquid 6 is maintained to be flush with the upper surface 51a of the first peripheral wall portion 51 of the liquid storage unit 5. Thus, the distance t between the head unit 2 and the liquid level 60 of the liquid 6 in the Z direction can be kept constant, so the landing accuracy of the ink in the ejecting step can be maintained.

As illustrated in FIG. 1A, the liquid 61 overflowing from the space Ra is stored in the space Rb of the liquid storage unit 5, and finally discharged to the outside through the drain hose 53 (discharging step).

The discharged liquid 6 may be discarded or reused.

### Formation of Ink Layer L2

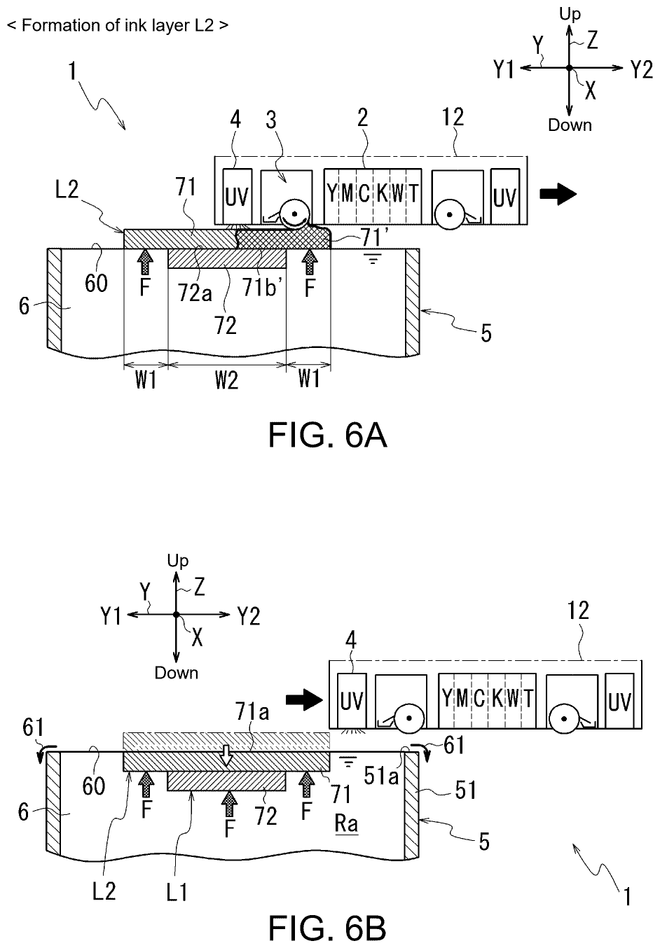

FIGS. 6A and 6B are views illustrating formation of the ink layer L2. FIG. 6A is a view illustrating ejection of ink. FIG. 6B is a view illustrating the ink layer L2.

As illustrated in FIG. 6A, the producing apparatus 1 ejects the ink from the head unit 2 toward the liquid 6 while moving the carriage 12 in the Y2 direction (black arrow in the drawing).

As illustrated in FIG. 4B, the coloring portion 71 of the ink layer L2 has a larger area than the ejecting base 72, and is provided in a range crossing the ejecting base 72 in the Y direction. Therefore, as illustrated in FIG. 6A, the ink ejected from the head unit 2 lands in a range straddling the upper surface 72a of the ejecting base 72 provided on the same plane and the liquid level 60 of the liquid 6.

Thus, as illustrated in FIG. 6A, a coloring portion 71′ has overhang regions W1 and W1 protruding in the Y direction from the ejecting base 72, and an overlap region W2 overlapping the ejecting base 72. In the lower surface 71b′ of the coloring portion 71′, the overhang regions W1 and W1 are in contact with the liquid level 60 of the liquid 6, and the overlap region W2 is in contact with the upper surface 72a of the ejecting base 72.

That is, the overhang regions W1 and W1 of the coloring portion 71′ are aligned with the overlap region W2 in the Z direction.

The buoyancy F acts on the overhang regions W1 and W1 of the lower surface 71b′ of the coloring portion 71′ from the liquid 6 (hatched arrow in the drawing). The overlap region W2 of the lower surface 71b′ of the coloring portion 71′ is supported by the ejecting base 72. Therefore, the coloring portion 71′ is maintained in a state (horizontal state) parallel to the liquid level 60 over the entire length in the Y direction.

Then, the producing apparatus 1 further moves the carriage 12 in the Y2 direction while buoyancy acts on the overhang regions W1 and W1, and flattens the coloring portion 71′ by the roller unit 3 and cures the coloring portion 71′ by the ultraviolet irradiating unit 4. Thus, the coloring portion 71 formed with the cured ink is formed as the ink layer L2.

As illustrated in FIG. 6B, the coloring portion 71 after curing sinks to the lower side in the Z direction by its own weight while the positions in the X and Y directions are maintained (white arrow in the drawing). In this case, the coloring portion 71 and the ejecting base 72 are balanced with the buoyancy F at a position where the upper surface 71a is flush with the liquid level 60. The ink layer L1 and the ink layer L2 are laminated in the liquid 6 while being kept horizontal (laminating step).

Then, the liquid 61 overflows from the space Ra of the liquid storage unit 5 by the volume by which the ink layer L2 (coloring portion 71) sinks in the liquid 6. Accordingly, the liquid level 60 of the liquid 6 is maintained to be flush with the upper surface 51a of the first peripheral wall portion 51 of the liquid storage unit 5.

### Formation of Ink Layer L3

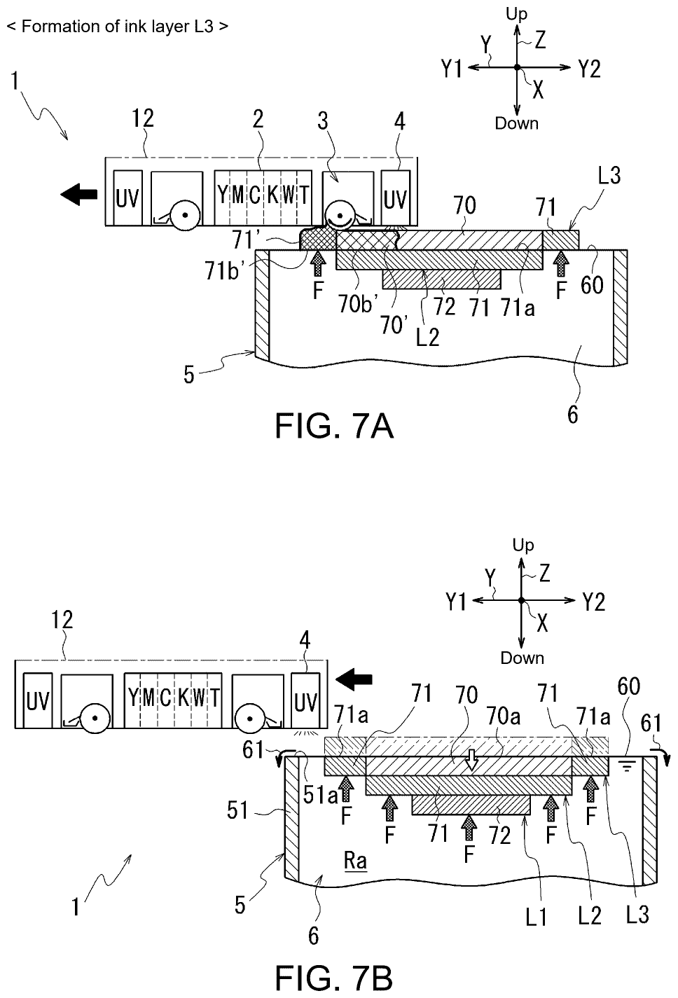

FIGS. 7A and 7B are views illustrating the formation of the ink layer L3. FIG. 7A is a view illustrating ejection of ink. FIG. 7B is a view illustrating the ink layer L3.

As illustrated in FIG. 7A, the producing apparatus 1 ejects the ink from the head unit 2 toward the liquid 6 while moving the carriage 12 in the Y1 direction (black arrow in the drawing).

As illustrated in FIG. 4B, the ink layer L3 has a larger area than the ink layer L2, and is provided in a range crossing the ink layer L2 in the Y direction. Specifically, the solid portion 70 of the ink layer L3 has an area substantially matching the coloring portion 31 of the ink layer L2. The coloring portion 71 of the ink layer L3 is provided on the outer periphery of the solid portion 70, and protrudes in the Y direction from the coloring portion 71 of the ink layer L2.

Thus, as illustrated in FIG. 7A, the ink ejected from the head unit 2 lands in a range straddling the upper surface 71a of the coloring portion 71 of the ink layer L2 and the liquid level 60 of the liquid 6. Thus, the coloring portion 71′ overhangs in the Y direction than the coloring portion 71 of the ink layer L2. The lower surface 71b′ of the coloring portion 71′ is in contact with the liquid level 60 of the liquid 6. The lower surface 70b′ of the solid portion 70′ is in contact with the upper surface 71a of the coloring portion 71 of the ink layer L2.

The buoyancy Facts on the lower surface 71b′ of the coloring portion 71′ from the liquid 6 (hatched arrow in the drawing). The lower surface 70b′ of the solid portion 70′ is supported by the coloring portion 71 of the ink layer L2. Therefore, the solid portion 70′ and the coloring portion 71′ are maintained in a state of being parallel to the liquid level 60 over the entire length in the Y direction.

Then, the producing apparatus 1 further moves the carriage 12 in the Y2 direction to flatten the solid portion 70′ and the coloring portion 71′ by the roller unit 3 and cure the solid portion 70′ and the coloring portion 71′ by the ultraviolet irradiating unit 4. As a result, the solid portion 70 and the coloring portion 71 formed with the cured ink are formed as the ink layer L3.

As illustrated in FIG. 7B, the solid portion 70 and the coloring portion 71 after curing sink downward in the Z direction by their own weight while the positions in the X and Y directions are maintained (white arrow in the drawing). In this case, the solid portion 70 and the coloring portion 71 are balanced with the buoyancy F at a position where the upper surfaces 70a and 71a are flush with the liquid level 60. The ink layers L1 to L3 are laminated in the liquid 6 while being kept horizontal.

Then, the liquid 61 overflows from the space Ra of the liquid storage unit 5 by the volume in which the ink layer L3 (the solid portion 70 and the coloring portion 71) sinks in the liquid 6. Accordingly, the liquid level 60 of the liquid 6 is maintained to be flush with the upper surface 51a of the first peripheral wall portion 51 of the liquid storage unit 5.

In the same manner, an ejecting step of ejecting the ink from the head unit 2 toward the liquid 6, a flattening step of flattening the ink with the roller unit 3, and a curing step of curing the ink with the ultraviolet irradiating unit 4 are repeated to form the ink layers L4 to Ln. Thus, the ink layers are sequentially laminated in the liquid 6 to produce the shaped object 7 (see FIG. 4B).

Thus, in the method for producing the shaped object 7 according to this embodiment, the buoyancy of the liquid 6 can be used instead of the support material by ejecting the ink toward the liquid 6.

When the shaped object 7 is produced using the conventional support material, the ink for the support material and the ink for the coloring portion 71 are mixed at the interface before the ink cures. As a result, the surface of the coloring portion 71 may become rough, and the quality and shaping accuracy of the surface of the shaped object 7 may deteriorate.

On the other hand, in the method for producing the shaped object 7 according to this embodiment, the surface of the coloring portion 71 of the shaped object 7 is in contact with the liquid 6 (see FIG. 4B). As described above, the liquid 6 contains polyvinyl alcohol (PVA), borax, and water. Therefore, the liquid 6 is hardly mixed at the interface with the coloring portion 71. Therefore, the quality of the surface of the coloring portion 71 and the shaping accuracy are less likely to be influenced than in the case of using the conventional support material.

Therefore, fine color expression and fine shaping expression of the shaped object, which are advantages of the inkjet method, can be utilized.

As described above, the method for producing the shaped object 7 according to this embodiment includes the following steps.
(1) The method for producing the shaped object 7 shapes the three-dimensional shaped object 7.

The method for producing the shaped object 7 includes:
an ejecting step of ejecting ink from the head unit 2 to the liquid 6 stored in the liquid storage unit 5; and
a curing step of curing the ink ejected to the liquid 6 by an ultraviolet curing unit 4.

In the producing method of this embodiment, the three-dimensional shaped object can be shaped without using the support material. Therefore, in the production of the shaped object 7, the labor and cost related to the removal of the support material and the processing of the waste liquid from which the support material has been removed are reduced. Furthermore, the influence of gravity applied to the overhang portion of the shaped object 7 can be reduced. Furthermore, as compared with the case of using the conventional support material, the liquid 6 is less likely to mix at the interface with the coloring portion 71. Therefore, since the surface of the shaped object 7 is less likely to be influenced than the support material, the surface quality and the shaping accuracy of the coloring portion 71 of the shaped object 7 are improved.
(2) The method for producing the shaped object 7 includes a laminating step of laminating the ink layers L1 to Ln in the liquid 6 by repeating the ejecting step and the curing step.

When the shaped object 7 is produced in this manner, for example, in the relationship of the ink layers L1 and L2, the ink layer L2 on the upper layer side has the overhang regions W1 and W1 protruding from the ink layer L1 on the lower layer side.

The buoyancy F is applied from the liquid 6 to the overhang regions W1 and W1 in the ink layer L2. As a result, the influence of gravity applied to the overhang regions W1 and W1 can be reduced.
(3) The method for producing the shaped object 7 includes a discharging step of discharging the liquid 61 of the same volume as the formed ink layer whenever the ink layers L1 to Ln are formed.

In the producing method of this embodiment, since the distance t between the head unit 2 and the liquid level 60 of the liquid 6 can be kept constant, the landing accuracy of the ink in the ejecting step can be maintained.
(5) The ink may be an ultraviolet curable ink.

Since the ink can be quickly cured by using the ultraviolet curable ink, the time required to produce the shaped object 7 can be shortened.
(13) The method for ejecting the ink can be an inkjet method.

By layering the ink layers in the liquid 6, the surface quality and shaping accuracy of the surface of the coloring portion 1 of the shaped object 7 are improved than those using the support material. Therefore, by using the inkjet method, fine color expression and fine shaping expression, which are advantages of the inkjet method, can be utilized.

The producing apparatus 1 for producing the shaped object 7 according to this embodiment has the following configuration.
(14) The producing apparatus 1 shapes the three-dimensional shaped object 7.

The producing apparatus 1 includes the liquid storage unit 5 that holds the liquid 6;
the head unit 2 (ejecting unit) that ejects ink onto the liquid 6; and
the ultraviolet irradiating unit 4 (curing unit) that cures the ink ejected to the liquid 6.

According to such configuration, the influence of gravity applied to the overhang portion of the shaped object 7 can be reduced without using the support material. Furthermore, since the liquid 6 is less likely to influence the surface of the shaped object 7 than the support material, the surface quality and shaping accuracy of the coloring portion 71 of the shaped object 7 are improved.
(15) The producing apparatus 1 includes a second peripheral wall portion 52 and a drain hose 53 (recovery unit) for recovering the liquid 61 overflowing from the space Ra of the liquid storage unit 5.

With this configuration, the distance t between the head unit 2 and the liquid level 60 of the liquid 6 can be kept constant, so the landing accuracy of the ink on the liquid 6 can be maintained.
(18) The head unit 2 can be an inkjet head.

By ejecting the ink from the inkjet head, fine color expression and fine shaping can be performed.

The method for producing the shaped object 7 according to this embodiment includes the following steps.

(I) The method for producing the shaped object 7 shapes the three-dimensional shaped object 7.

A method for producing the shaped object 7 includes:
an ejecting step of ejecting ink from the head unit 2 to the liquid 6 stored in the liquid storage unit 5; and
a curing step of curing the ink ejected to the liquid 6 by the ultraviolet curing unit 4,
wherein the ink was composed of a composition in which the specific gravity before curing is lighter than that of liquid 6 and the specific gravity after curing is heavier than that of liquid 6.

When the shaped object 7 is produced in this manner, for example, as illustrated in FIG. 5B, the ink (ejecting base 72) after curing sinks in the liquid 6 by its own weight. Thus, as illustrated in FIG. 6A, in the ink (coloring portion 71′) to be ejected next, the overhang regions W1 and W1 and the overlap region W2 land on the liquid level 60 of the liquid 6 and the upper surface 72a of the ejecting base 72 which are on the same plane.

Therefore, the positions of the overhang regions W1 and W1 of the coloring portion 71 and the overlap region W2 in the Z direction (laminating direction) can be aligned in the ink layer L2 without using the support material. The same applies to the ink layers L3 to Ln.

(II) The ink before curing can have a viscosity of 15 mPa·s or more and 30 mPa·s or less.

According to such configuration of the ink, the ejected ink can be reduced from spreading on the liquid level 60 of the liquid 6.

(IV) The method for producing the shaped object 7 includes a base forming step of forming an ejecting base 72, which is a table on which the shaped object 7 is placed, with ink prior to the shaping of the shaped object 7.

By forming the ejecting base 72 as the ink layer L1, the ink layers L2 to Ln constituting the shaped object 7 can be laminated while the horizontal is ensured.

(V) The method for ejecting the ink can be an inkjet method.

By layering the ink layers in the liquid 6, the surface quality and shaping accuracy of the surface of the coloring portion 1 of the shaped object 7 are improved than those using the support material. Therefore, by using the inkjet method, fine color expression and fine shaping expression, which are advantages of the inkjet method, can be utilized.

The producing apparatus 1 for producing the shaped object 7 according to this embodiment has the following configuration.

(VI) The producing apparatus 1 shapes the three-dimensional shaped object 7.

The producing apparatus 1 includes:
the liquid storage unit 5 that holds the liquid 6;
the head unit 2 (ejecting unit) that ejects ink onto the liquid 6; and
the ultraviolet irradiating unit 4 (curing unit) that cures the ink ejected to the liquid 6,
wherein the ink is formed of a composition having a specific gravity lighter than that of the liquid 6 before curing and a specific gravity heavier than that of the liquid 6 after curing.

According to such a configuration, for example, as illustrated in FIG. 5B, the ink (ejecting base 72) after curing sinks in the liquid 6 by its own weight. Thus, as illustrated in FIG. 6A, in the ink (coloring portion 71′) to be ejected next, the overhang regions W1 and W1 and the overlap region W2 land on the liquid level 60 of the liquid 6 and the upper surface 72a of the ejecting base 72 which are on the same plane.

Therefore, the positions of the overhang regions W1 and W1 of the coloring portion 71 and the overlap region W2 in the Z direction (laminating direction) can be aligned in the ink layer L2 without using the support material. The same applies to the ink layers L3 to Ln.

(VII) The head unit 2 may be an inkjet head.

By ejecting the ink from the inkjet head, fine color expression and fine shaping can be performed.

In this embodiment, the case where the ejecting step, the flattening step, and the curing step are performed in one pass has been exemplified, but the present invention is not limited thereto. These steps may be divided into a plurality of passes. For example, the first pass may be the ejecting step, the second pass may be the flattening step, and the third pass may be the curing step.

In this embodiment, the ejecting base 72 is formed to secure the horizontal position prior to the shaping of the shaped object 7, but the present invention is not limited to this aspect. For example, prior to the shaping of the shaped object 7, the liquid level 60 of the liquid 6 may be flattened by the roller unit 3 to ensure the horizontal. In this case, the coloring portion 71 (see FIG. 4B) of the ink layer L2 can be directly formed on the liquid level 60 that is horizontal without forming the ejecting base 72. Further, a roller or a scraper different from the roller unit 3 may be provided in the carriage 12, and the liquid level 60 of the liquid 6 may be made horizontal by the roller or the scraper.

As illustrated in FIG. 5A, in this embodiment, the method of adjusting the bite amount Δh by changing the protrusion amount ha of the roller portion 30 in the flattening by the roller unit 3 has been exemplified, but the present invention is not limited to this aspect. The bite amount Δh may be adjusted by adjusting the ejection amount of ink on the head unit 2 side. In this case, the thickness of the formed lower layer side ink layer is measured with a laser or light, and the ejection amount of ink is adjusted based on the measurement result. Alternatively, the protrusion amount ha and the rotation speed of the roller 301 may be adjusted using AI and machine learning. For example, the cross-sectional area (slice data) of the shaped object 7, the material of the shaped object 7, the physical properties of the ink, the physical properties (viscosity, thixotropy or specific gravity) of the liquid 6, and the like are learned.

In this embodiment, the liquid 6 having a predetermined viscosity includes polyvinyl alcohol (PVA), borax, and water, but the present invention is not limited to this aspect. The liquid 6 may have a predetermined viscosity by containing a material exhibiting thixotropy. For example, it may be water mixed with flour, soybean flour, or starch, or a resin material (monomer or oligomer) mixed with a filler.

(III) The liquid 6 can contain a material exhibiting thixotropy.

According to such configuration, the position of the ink that landed on the liquid level 60 of the liquid 6 can be reduced from shifting.

Further, by imparting adhesiveness to the liquid 6, the ink landed on the liquid level 60 of the liquid 6 may not move in the X and Y directions. As a method for imparting adhesiveness, adhesiveness may be imparted by dissolving an adhesive material in a volatile solvent (alcohol, water, acetone, or the like) and volatilizing the solvent by heat (the reaction heat between the ink and the liquid 6, the exhaust heat of the producing apparatus 1, a heating and cooling device 9 described later, and the like) at the time of shaping. Alternatively, an adhesive material that reacts with ultraviolet rays may be placed in the liquid 6 and irradiated with ultraviolet rays UV to impart adhesiveness. Alternatively, adhesiveness may be imparted using a mixture of natural rubber and petroleum resin, or a mixture of acrylic, urethane, or silicone-based resin to adjust the molecular weight and crosslinking density.

### Modified Example 1

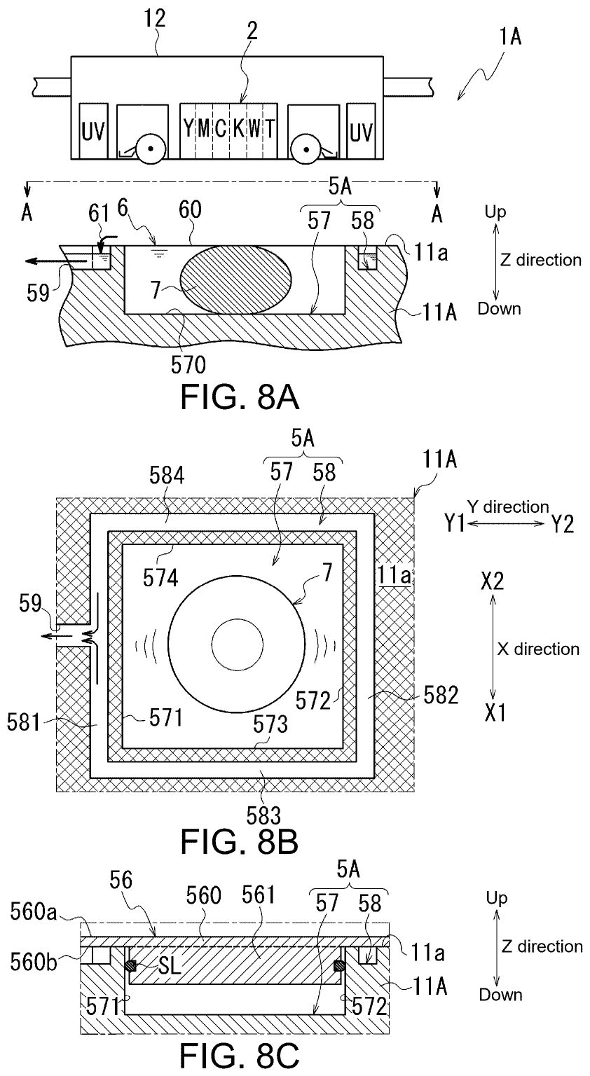

In the above-described embodiment, the liquid storage unit 5 is placed on the table 11 as a separate component, but the present invention is not limited to this aspect. For example, as illustrated in FIG. 8A, a producing apparatus 1A may be configured such that a table 11A itself is provided with a liquid storage unit 5A. In Modified Example 1 below, only parts different from the above-described embodiment will be described.

FIGS. 8A, 8B, and 8C are views illustrating the producing apparatus 1A according to Modified Example 1. FIG. 8A is a schematic configuration diagram of the producing apparatus 1A. FIG. 8B is a view illustrating the liquid storage unit 5A. FIG. 8B is a view taken along line A-A in FIG. 8A. FIG. 8C is a view illustrating another usage mode of the producing apparatus 1A.

As illustrated in FIG. 8A, the liquid storage unit 5A includes a recess 57 that opens in the upper surface 11a of the table 11, and a recessed groove 58 that surrounds the outer periphery of the recess 57. The recess 57 and the recessed groove 58 are recessed downward in the Z direction from the upper surface 11a of the table 11. A bottom surface 570 of the recess 57 is a flat surface parallel to the upper surface 11a of the table 11. The inside of the recess 57 is filled with the liquid 6. In the recess 57, the shaped object 7 is immersed in the liquid 6.

As illustrated in FIG. 8B, the recess 57 has a rectangular shape in plan view.

The recess 57 includes wall portions 571 and 572 provided in a direction along the X direction and wall portions 573 and 574 provided in a direction along the Y direction and connecting end portions of the wall portions 571 and 572.

The recessed groove 58 includes grooves 581 and 582 provided in a direction along the X direction, and grooves 583 and 584 provided in a direction along the Y direction and connecting end portions of the grooves 581 and 582. The grooves 581 to 584 of the recessed groove 58 is provided in parallel to the wall portions 571 to 574 of the recess 57.

As illustrated in FIG. 8B, the groove 571 of the recessed groove 58 is connected with a discharge groove 59 extending in a direction away from the recess 57 in the Y direction. The liquid 6 overflowing from the inside of the recess 57 passes through the grooves 581 to 584 and is ejected from the discharge groove 59 to the outside.

Here, the liquid storage unit 5A is directly formed on the table 11A. Therefore, the positions in the X and Y directions are fixed. As a result, as in the above-described embodiment, it is not necessary to provide the positioning pins Px and Py on the table 11 to perform the positioning operation of the liquid storage unit 5 (see FIG. 2). Therefore, the set-up work in the production of the shaped object 7 can be reduced.

When producing the shaped object 7 using the producing apparatus 1A, the ink is ejected from the head unit 2 to the liquid level 60 of the liquid 6 while the recess 57 is filled with the liquid 6 in advance. Then, the ejecting step and the curing step are repeated to shape the shaped object 7.

As illustrated in FIG. 8A, the overflowing liquid 61 is collected in the recessed groove 58 and the discharge groove 59. Thus, the shaped object 7 can be produced by the producing apparatus 1A including the liquid storage unit 5A.

Here, as illustrated in FIG. 8B, the producing apparatus 1A according to Modified Example 1 may include a cover 56 that closes the opening of the liquid storage unit 5A.

The cover 56 includes a plate portion 560 that covers the entire upper surface 11a of the table 11, and a thick portion 561 that protrudes from the other surface 560b in the thickness direction of the plate portion 560.

One surface 560a and the other surface 560b in the thickness direction of the plate portion 560 are flat surfaces parallel to each other.

The thick portion 56 has a rectangular shape in plan view. The thick portion 561 has an area slightly smaller than an area of a region surrounded by the wall portions 571 to 574 (see FIG. 8B) of the recess 57. On the outer periphery of the thick portion 561, a sealing material SL is provided over the entire periphery.

When the liquid storage unit 5A is closed by the cover 56, the thick portion 561 is inserted into the recess 57 and pushed until the other surface 560b of the plate portion 560 abuts on the upper surface 11a of the table 11. As a result, the opening of the liquid storage unit 5A is closed by the cover 56. In this case, one surface 560a of the plate portion 560 is a surface facing the head unit 2 (see FIG. 8A). Thus, the cover 56 also functions as a conventional shaping table. Since the sealing material SL is interposed between the thick portion 561 and the recess 57, the cover 56 can also be reduced in rattling during the shaping.

The producing apparatus 1A according to Modified Example 1 has the following configuration.
(16) The liquid storage unit 5A has the recess 57 in which the upper surface 11a of the table 11A (base) provided below the head unit 2 is opened.

The liquid 6 is stored in the recess 57.

The producing apparatus 1A includes the cover 56 that closes the opening of the recess 57.

With this configuration, since the position of the recess 57 on the table 11A is fixed, it is not necessary to provide the positioning pins Px and Py (see FIG. 2) to perform the positioning operation of the liquid storage unit 5 as in the above-described embodiment, and thus, it is possible to reduce the set-up work. The cover 56 can also be used as a conventional shaping table by closing the opening of the recess 57 with the cover 56.

### Modified Example 2

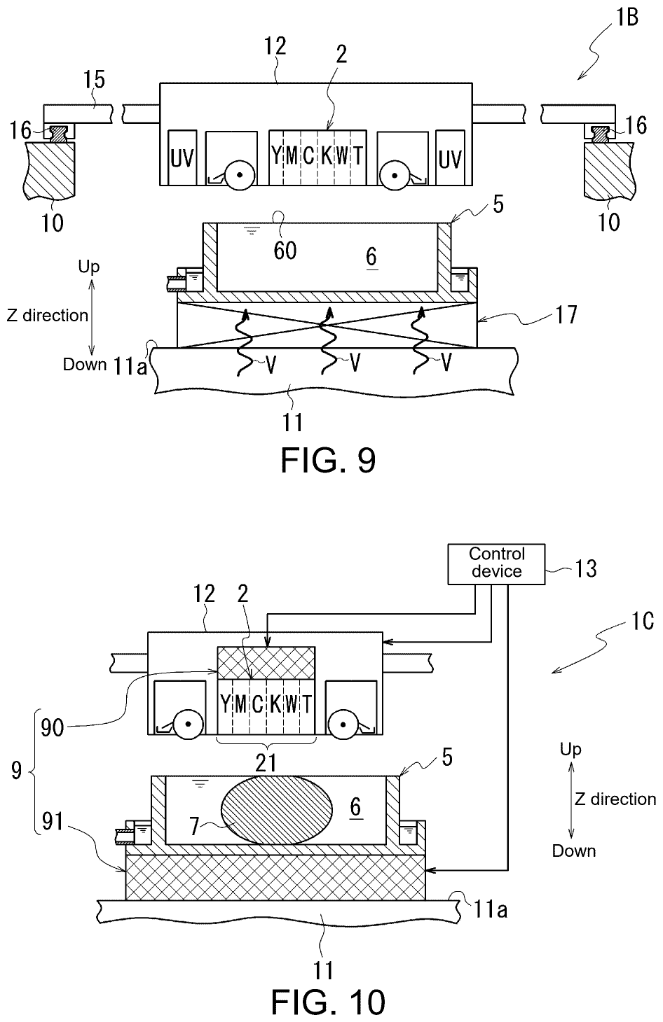

FIG. 9 is a view illustrating a producing apparatus 1B according to Modified Example 2.

As illustrated in FIG. 9, the guide rails 15 and 16 and a body frame 10 supporting the carriage 12 vibrate by receiving the inertial force of the carriage 12 when the carriage 12 is accelerated and decelerated in the X and Y directions. This vibration V is propagated to the table 11, and finally vibrates the liquid level 60 of the liquid 6 and the shaped object 7 in the liquid storage unit 5. When the liquid level 60 of the liquid 6 and the shaped object 7 in the liquid storage unit 5 vibrate, the landing position of the ink may shift. Furthermore, due to this vibration, the shaped object 7 may move in the liquid storage unit 5. Therefore, the producing apparatus 1B according to Modified Example 2 includes a vibration suppression mechanism 17 that attenuates the vibration V.

As illustrated in FIG. 9, in the producing apparatus 1B according to Modified Example 2, the vibration suppression mechanism 17 is provided between the liquid storage unit 5 and the upper surface 11a of the table 11A in the Z direction.

The vibration suppression mechanism 17 may be any mechanism as long as it can attenuate the vibration V, and examples thereof include a vibration-proof rubber, an air spring, a coil spring, a damper mechanism, and the like.

As a result, even if the table 11 vibrates due to acceleration and deceleration of the carriage 12, the vibration V of the table 11 is attenuated before being propagated to the liquid storage unit 5 and the liquid 6 by the vibration suppression mechanism 17. Therefore, the liquid level 60 of the liquid 6 and the shaped object 7 in the liquid storage unit 5 are shaken, and the landing position of the ink can be reduced from shifting. Furthermore, the shaped object 7 can be reduced from moving in the liquid storage unit 5.

The producing apparatus 1B according to Modified Example 2 has the following configuration.
(17) The producing apparatus 1B includes the vibration suppression mechanism 17 that suppresses vibration of the liquid 6 in the liquid storage unit 5.

The vibration suppression mechanism 17 is provided between the table 11 and the liquid storage unit 5.

With this configuration, the vibration V of the table 11 is attenuated before being propagated to the liquid storage unit 5 and the liquid 6 by the vibration suppression mechanism 17. Therefore, the liquid level 60 of the liquid 6 and the shaped object 7 in the liquid storage unit 5 are shaken, and the landing position of the ink can be reduced from shifting. Furthermore, the shaped object 7 can be reduced from moving in the liquid storage unit 5.

In the producing apparatus 1B according to Modified Example 2, the vibration suppression mechanism 17 is provided between the table 11 and the liquid storage unit 5, but the present invention is not limited to this aspect. For example, the table 11 itself may have a function of suppressing the vibration V.

### Modified Example 3

In the above-described embodiment, the producing apparatus 1 that irradiates ultraviolet UV from the ultraviolet irradiating unit 4 has been exemplified, but the present invention is not limited to this aspect. For example, a producing apparatus 1C that heats and cools the ink or the liquid 6 by the heating/cooling device 9 may be used. In Modified Example 3 below, only parts different from the above-described embodiment will be described.

FIG. 10 is a view illustrating the producing apparatus 1C according to Modified Example 3. In FIG. 10, a region where the heating/cooling device 9 is provided is cross-hatched.

As illustrated in FIG. 10, the producing apparatus 1C includes the heating/cooling device 9 instead of the ultraviolet irradiating unit 4 of the above-described embodiment. Examples of the heating/cooling device 9 include a device that performs heating/cooling using a Peltier element.

The heating/cooling device 9 includes a first heating/cooling unit 90 and a second heating/cooling unit 91. The first heating/cooling unit 90 is provided in the head unit 2, and heats and cools the ink in the head 21 (21Y to 21T). The second heating/cooling unit 91 is provided between the table 11 and the liquid storage unit 5, and heats and cools the liquid 6.

For example, when producing the shaped object 7 using the thermosetting ink, only the second heating/cooling unit 91 is driven to heat the liquid 6. The ink in the head 21 is at room temperature. Therefore, the temperature of the liquid 6 is higher than the temperature of the ink in the head 21.

When the ink is ejected from the head unit 2 toward the liquid 6, the ink that landed on the liquid level 60 is heated and cured by the liquid 6. The cured ink sinks in the liquid 6. By repeating this, the ink layers L1 to Ln are laminated in the liquid 6, and the shaped object 7 is produced. By using the thermosetting ink, the shaped object 7 having high heat resistance can be produced.

The method for producing the shaped object 7 according to Modified Example 3 includes the following steps.
(1, 11) The method for producing the shaped object 7 shapes the three-dimensional shaped object 7.

The method for producing the shaped object 7 includes:
an ejecting step of ejecting a thermosetting ink from the head unit 2 to the liquid 6 stored in the liquid storage unit 5; and
a curing step of heating the liquid 6 by driving the second heating/cooling unit 91 of the heating/cooling device 9 and curing the ink by heating the ink ejected to the liquid 6.

The producing method of this embodiment can produce the shaped object 7 having high heat resistance.

Furthermore, when producing the shaped object 7 using the thermoplastic ink, the first heating/cooling unit 90 is driven to heat the ink in the head 21, and the second heating/cooling unit 91 is driven to cool the liquid 6. Therefore, the temperature of the ink in the head 21 is higher than that of the liquid 6.

When the ink is ejected from the head unit 2 toward the liquid 6, the ink that landed on the liquid level 60 is cooled and cured by the liquid 6. The cured ink sinks in the liquid 6. By repeating this, the ink layers L1 to Ln are laminated in the liquid 6, and the shaped object 7 is produced. Since the thermoplastic ink has high viscosity, the thermoplastic ink can be stably ejected, and spreading of the ink in the liquid 6 can be reduced.

### Modified Example 4

In the above-described embodiment and Modified Examples 1 to 3, the liquid storage unit 5 is disposed in advance on the table 11, and the shaping is performed while the inside of the liquid storage unit 5 is filled with the liquid 6. However, the present invention is not limited to this aspect. In Modified Example 4, an example in which the shaping of the shaped object 7 is performed in parallel while shaping a liquid storage unit 5B with ink on the table 11 will be described. In Modified Example 4 below, only parts different from the above-described embodiment will be described.

FIG. 11 is a view illustrating a producing apparatus 1D according to Modified Example 4. In FIG. 11, the shaped object 7 and the liquid storage unit 5B produced by the producing apparatus 1D are indicated by virtual lines.

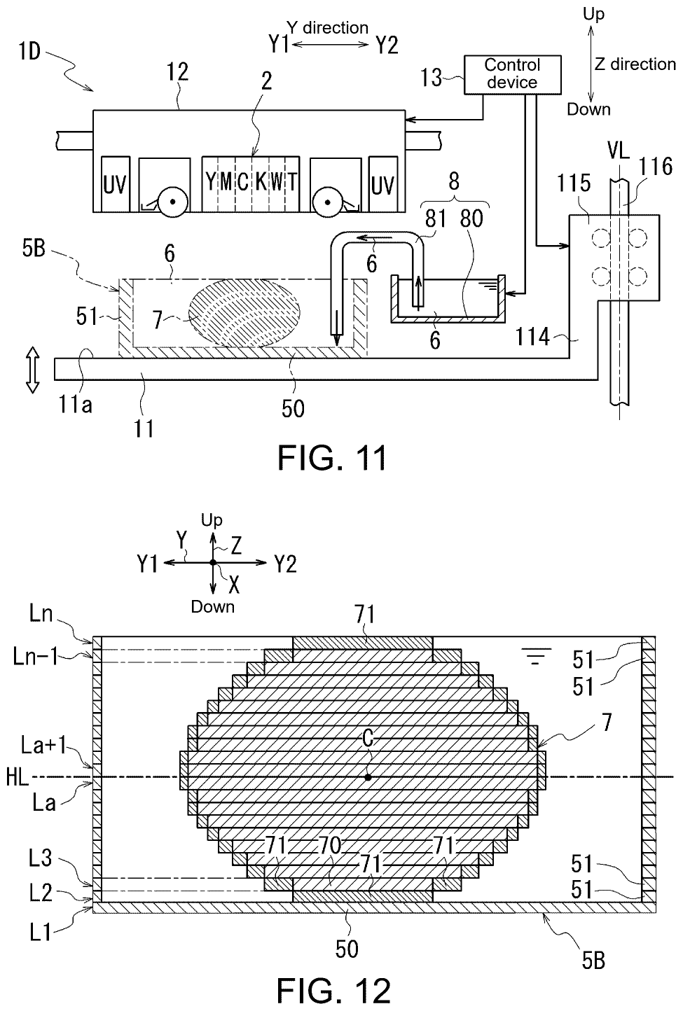

FIG. 12 is a view illustrating slice data of the shaped object 7 including the liquid storage unit 5B.

In the liquid storage unit 5B according to Modified Example 4, a liquid storage unit not including the second peripheral wall portion 52 described above will be exemplified.

In the producing apparatus 1D according to Modified Example 4, a connecting arm 114 extending in the Z direction is connected to one side of the table 11. A connecting portion 115 provided on the upper portion of the connecting arm 12 is connected to a guide rail 116 disposed along the vertical line VL parallel to the Z direction.

In this state, the connecting portion 115 is provided to be movable along the Z direction of the guide rail 116. When a drive mechanism (not illustrated) provided inside the connecting portion 115 operates based on a command from the control device 13, the table 11 connected to the connecting portion 115 via the connecting arm 114 moves in the vertical direction (white arrow in the drawing).

As illustrated in FIG. 11, the producing apparatus 1D includes the supply unit 8 that supplies the liquid 6 into the liquid storage unit 5B. The supply unit 8 includes a tank 80 that stores the liquid 6 and a hose 81 provided across the tank 80 and the liquid storage unit 5B. Although not illustrated, the supply unit 8 has a moving mechanism that moves the tank 80 and the hose 81 in the Y direction and the Z direction. In addition, although not illustrated, the hose 81 is provided with a valve for switching between circulation and interruption of the liquid 6 from the tank 80. The moving mechanism and the valve are controlled by the control device 13.

When the liquid 6 is supplied into the liquid storage unit 5B, the supply unit 8 moves the tank 80 to a position offset upward from the liquid level 60 of the liquid storage unit 5B based on a command from the control device 13. As a result, the liquid 6 moves by a predetermined amount from the tank 80 side to the liquid storage unit 5B side by the principle of siphoning. When shaping the liquid storage unit 5B with ink, the supply unit 8 moves in the Y direction to avoid interference with the carriage 12.

The moving mechanism may move the tank 80 and the hose 81 in the X direction to avoid interference with the carriage 12.

As illustrated in FIG. 12, in the producing apparatus 1D, the shaped object 7 and the liquid storage unit 5B are sliced (partitioned) at equal intervals in the Z direction to set N ink layers (L1 to Ln: n are arbitrary integers).

In the ink layer L1, the bottom wall portion 50 of the liquid storage unit 5B is formed instead of the ejecting base 72 (see FIG. 4B). The coloring portion 71 and the first peripheral wall portion 51 are formed on the ink layers L2 and Ln. The solid portion 70, the coloring portion 71, and the first peripheral wall portion 51 are formed in the ink layers L3 to Ln−1. That is, the ink layers corresponding to the shaped object 7 are the ink layers L2 to Ln. For example, white (W) ink can be used for forming the bottom wall portion 50 and the first peripheral wall portion 51.

Hereinafter, a method for producing the shaped object 7 using the producing apparatus 1D according to Modified Example 4 will be described.

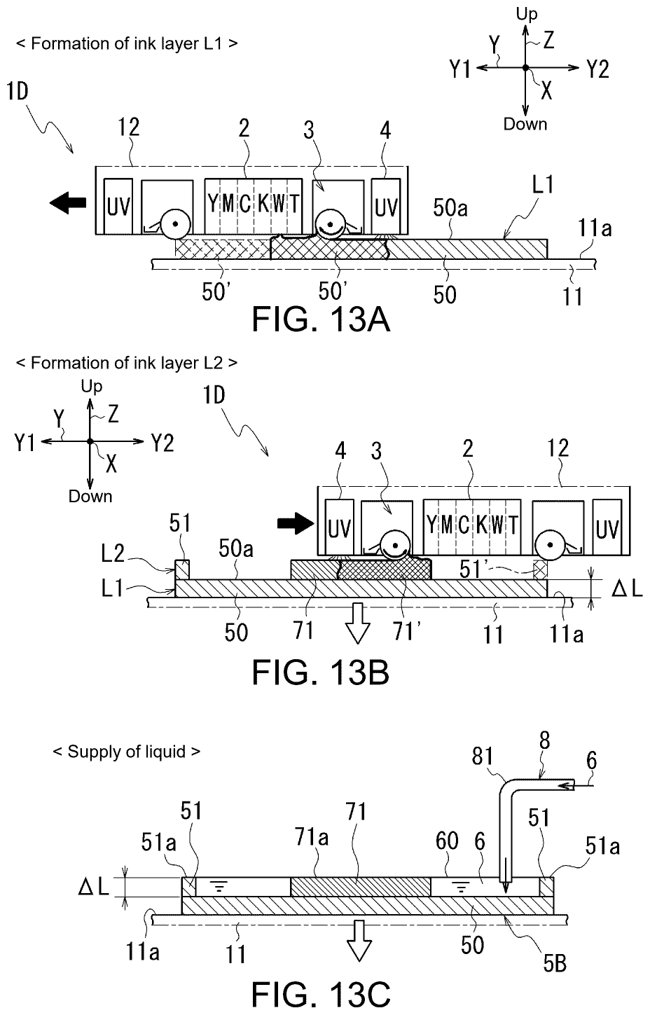

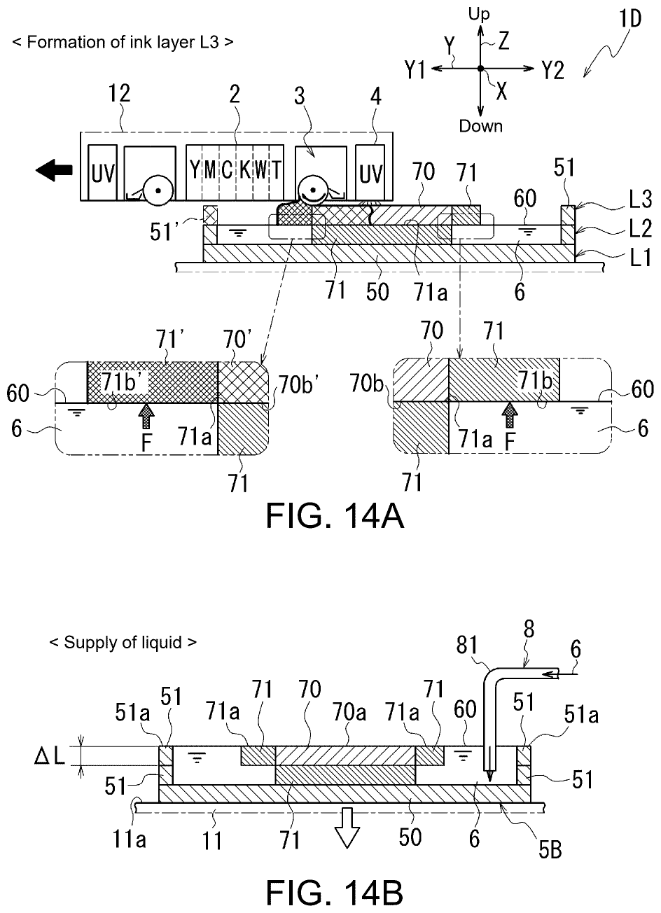

FIGS. 13 and 14 are views for sequentially illustrating the production of the liquid storage unit 5B and the shaped object 7.

FIGS. 13A, 13B, and 13C are views illustrating the production of the shaped object 7 according to Modified Example 4. FIG. 13A is a view illustrating the formation of the ink layer L1. FIG. 13B is a view illustrating the formation of the ink layer L2. FIG. 13C is a view illustrating the supply of the liquid 6.

FIGS. 14A and 14B are views illustrating the production of the shaped object 7 according to Modified Example 4. FIG. 14A is a view illustrating the formation of the ink layer L3. FIG. 14B is a view illustrating the supply of the liquid 6.

### Formation of Ink Layer L1

As illustrated in FIG. 13A, the producing apparatus 1D ejects ink from the head unit 2 toward the upper surface 11a of the table 11 while moving the carriage 12 in the Y1 direction (black arrow in the drawing). Further, the producing apparatus 1D flattens a bottom wall portion 50′ with the roller unit 3 and cures the bottom wall portion by the ultraviolet irradiating unit 4 while moving the carriage 12 in the Y1 direction. Thus, the bottom wall portion 50 is formed as the ink layer L1. The upper surface 50a of the bottom wall portion 50 is a horizontal plane along the X and Y directions.

### Formation of Ink Layer L2

As illustrated in FIG. 13B, when the formation of the bottom wall portion 50 is completed, the table 11 is offset downward in the Z direction by the thickness AL of the ink layer L1 along the guide rail 116 (see FIG. 11) (white arrow in FIG. 13B).

Next, the producing apparatus 1D ejects ink from the head unit 2 toward the upper surface 50a of the bottom wall portion 50 while moving the carriage 12 in the Y2 direction (black arrow in the drawing). Specifically, the head unit 2 ejects the ink to be the first peripheral wall portion 50′ to both ends of the bottom wall portion 51 in the Y direction, and ejects the ink to be the coloring portion 71′ to a substantially intermediate position of the bottom wall portion 50 in the Y direction.

Furthermore, the producing apparatus 1D flattens the first peripheral wall portion 51′ and the coloring portion 71′ with the roller unit 3 and cures by the ultraviolet irradiating unit 4 while moving the carriage 12 in the Y2 direction. As a result, the first peripheral wall portions 51 and 51 and the coloring portion 71 are formed as the ink layer L2 on the upper surface 50a of the bottom wall portion 50. A part of the liquid storage unit 5B is formed by forming the bottom wall portion 50 and a part of the first peripheral wall portions 51 and 51.

When forming the ink layers L1 and L2, the supply unit 8 is retracted while avoiding interference with the carriage 12. The valve of the hose 81 is closed to block the flow of the liquid 6 from the tank 80.

### Supply of Liquid 6

As illustrated in FIG. 13C, the supply unit 8 moves above the liquid storage unit 5B and supplies the liquid 6 into the liquid storage unit 5B by opening the valve of the hose 81. The supply unit 8 supplies the liquid 6 of the same height as the thickness AL of the ink layer L2 by offsetting the tank 80 (see FIG. 11) to the upper side in the Z direction by a predetermined amount (supplying step). The offset amount of the tank 80 can be set in advance by the control device 13 or the like.

Thus, the upper surface 51a of the first peripheral wall portion 51, the upper surface 71a of the coloring portion 71, and the liquid level 60 of the liquid 6 in the ink layer L2 are flush with each other.

After the liquid 6 is supplied, the carriage 12 may be further moved in the Y1 direction to flatten the liquid level 60 with the roller unit 3. As a result, it is possible to cope with a case where there is a variation in the supply amount of the liquid 6 by the supply unit 8.

When the supply of the liquid 6 is completed, the table 11 is offset downward in the Z direction by the thickness AL of the ink layer L2 along the guide rail 116 (see FIG. 11) (white arrow in FIG. 13C). After shutting off the valve of the hose 81, the supply unit 8 moves upward and retracts to avoid interference with the first peripheral wall portion 51, and then moves in the Y direction and retracts to avoid interference with the carriage 12.

### Formation of Ink Layer L3

As illustrated in FIG. 14A, the producing apparatus 1D ejects the ink from the head unit 2 toward the first peripheral wall portion 51 and the coloring portion 71 of the ink layer L2 while moving the carriage 12 in the Y1 direction (black arrow in the drawing).

As illustrated in FIG. 14A, the coloring portion 71 of the ink layer L3 protrudes in the Y direction from the coloring portion 71 of the ink layer L2.

Therefore, in the ink layer L3, among the inks ejected from the head unit 2, the ink constituting the coloring portion 71′ is overhung and laminated from the ink layer L2. Among the inks ejected from the head unit 2, the ink constituting the first peripheral wall portion 51′ is laminated from the ink layer L2 without overhanging.

As illustrated in the enlarged region of FIG. 14A, the lower surface 71b′ of the coloring portion 71′ is in contact with the liquid level 60 of the liquid 6. The lower surface 70b′ of the solid portion 70′ is in contact with the upper surface 71a of the coloring portion 71 of the ink layer L2.

The buoyancy Facts on the lower surface 71b′ of the coloring portion 71′ from the liquid 6 (hatched arrow in the drawing). The lower surface 70b′ of the solid portion 70′ is supported by the coloring portion 71 of the ink layer L2. Therefore, the solid portion 70′ and the coloring portion 71′ are maintained in a state of being parallel to the liquid level 60 over the entire length in the Y direction.

Then, the producing apparatus 1D further moves the carriage 12 in the Y1 direction to perform flattening by the roller unit 3 and curing by the ultraviolet irradiating unit 4. As a result, the first peripheral wall portions 51 and 51, the solid portion 70, and the coloring portion 71 are formed as the ink layer L3.

### Supply of Liquid 6

As illustrated in FIG. 14B, the supply unit 8 moves above the liquid storage unit 5B and supplies the liquid 6 into the liquid storage unit 5B by opening the valve of the hose 81. The supply unit 8 supplies the liquid 6 having the same height as the thickness AL of the ink layer L3. As a result, the upper surface 51a of the first peripheral wall portion 51, the upper surface 70a of the solid portion 70, the upper surface 71a of the coloring portion 71, and the liquid level 60 of the liquid 6 in the ink layer L3 are flush with each other.

When the supply of the liquid 6 is completed, the table 11 is offset downward in the Z direction by the thickness AL of the ink layer L3 along the guide rail 116 (see FIG. 11) (white arrow in FIG. 14B).

In the same manner, an ejecting step of ejecting the ink from the head unit 2 toward the liquid 6, a flattening step of flattening the ink with the roller unit 3, a curing step of curing the ink with the ultraviolet irradiating unit 4, and a supplying step of supplying the liquid 6 are repeated to form the ink layers L4 to Ln. Thus, the ink layers are sequentially laminated to produce the liquid storage unit 5B and the shaped object 7 (see FIG. 12).

Since the shaped object 7 does not have the overhang region above the horizontal line HL passing through the center C of the shaped object 7, the shaping of the first peripheral wall portion 51 and the supply of the liquid 6 may be limited to the region constituting the ink layer La in the Z direction. The shape can be appropriately changed according to the shape of the shaped object 7.

Thus, it is not necessary to prepare the liquid storage unit 5 and the liquid 6 in advance as in the above-described embodiment, and the shaped object 7 can be substantially automatically produced by reducing the set-up work.

The method for producing the shaped object 7 according to Modified Example 4 includes the following steps.
(4) A supplying step of supplying the liquid 6 of the same height as the thickness ΔL of each of the ink layers L2 to Ln is included whenever the ink layers L2 to Ln corresponding to the shaped object 7 are formed.

In the producing method of Modified Example 4, since the operation of arranging the liquid storage unit on the table 11 and storing the liquid 6 in the liquid storage unit in advance can be omitted, the set-up work can be reduced.

### Modified Example 5

In the above-described embodiment and modified example 3, a method of applying energy from the outside to cure the ink, such as irradiation of ultraviolet ray UV by the ultraviolet ray irradiating unit 4 (see FIGS. 5A and 5B) and heating of the ink or the liquid 6 by the heating/cooling device 9 (see FIG. 10), has been exemplified, but the present invention is not limited to this aspect. For example, ink containing a material serving as a main agent and a liquid 6A containing a material serving as a curing agent may be mixed with the liquid 6A to be naturally cured. Furthermore, various performances can be added to the shaped object 7 by changing the combination of the material to become the main agent and the material to become the curing agent.

In the following description, a case where ink formed of an epoxy resin and the liquid 6A formed of an amine curing agent are used will be described as an example.

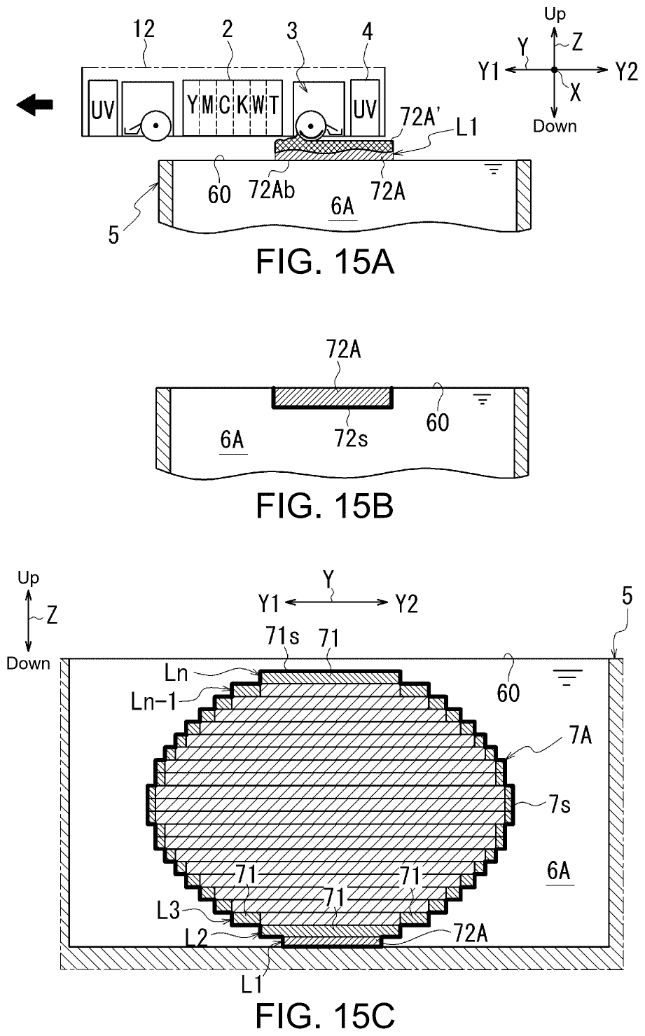

FIGS. 15A, 15B, and 15C are views illustrating the production of the shaped object 7A according to Modified Example 5. FIG. 15A is a view illustrating the formation of the ink layer L1. FIG. 15B is a view illustrating the ink layer L1 in the liquid 6A. FIG. 15C is a view illustrating the shaped object 7A.

As illustrated in FIG. 15A, when forming an ejecting base 72A configuring the ink layer L1, the ink is ejected from the head unit 2 toward the liquid 6A while moving the carriage 12 in the Y1 direction (in the direction of the black arrow in the drawing). The ejecting base 72A′ including the uncured ink floats on the liquid level 60 of the liquid 6A.

The ejecting base 72A′ is in contact with the liquid 6. Therefore, the ejecting base 72A′ is cured from a lower surface 72Ab side serving as an interface. The ejecting base 72A′ is flattened by the roller unit 3 while being cured on the lower surface 72Ab side.

As illustrated in FIG. 15B, the cured ejecting base 72A sinks in the liquid 6A.

Here, the ink is an epoxy resin, and the liquid 6A is an amine curing agent. Therefore, in the cured ejecting base 72, in particular, the surface 72s which is a portion in contact with the liquid 6A has high hardness. Furthermore, by sequentially layering the ink layers L2 to Ln, the hardness of the surface 7s in contact with the liquid 6A becomes high in the shaped object 7A (see FIG. 15C). Thus, the shaped object 7A having high corrosion resistance and scratch resistance can be produced.

In order to cure the surface 71s of the coloring portion 71 constituting the ink layer Ln, the depth of the liquid storage unit 5 may be set to a depth at which the shaped object 7A can be submerged in the liquid 6A.

In the method for producing the shaped object 7A according to Modified Example 5,
(6, 8) As the ink, one containing an epoxy resin as a main material can be used.

As the liquid 6A, a material containing an amine-based curing agent can be used as a material serving as a curing agent.

When the liquid 6A is mixed with the ink, the ink is cured.

Thus, various performances can be added to the shaped object by changing the combination of the material serving as the main agent and the material serving as the curing agent. Specifically, by using an epoxy-based resin, the hardness of a surface 7s of the shaped object 7A is increased, and the shaped object 7A having high corrosion resistance and scratch resistance can be produced.

### Other Modified Examples

Hereinafter, other modified examples will be described with reference to FIG. 15a, 15b, and 15c.

The combination of the material serving as the main agent and the material serving as the curing agent is not limited to the epoxy resin and the amine curing agent.

For example, the ink may contain a metal catalyst component, and the liquid 6A may contain a peroxide component. Thus, the shaped object 7A formed of an acrylic resin is produced. By using the acrylic resin, the shaped object 7A having high transparency can be produced.
(7) As the ink, one containing a metal catalyst component can be used.

As the liquid 6A, one containing a peroxide component can be used.

When the ink and the liquid 6A are configured as described above, the shaped object 7A formed of an acrylic resin having high transparency can be produced.

The ink may contain a platinum catalyst component, and the liquid 6A may be a crosslinking agent having a hydrosilyl group. Thus, the shaped object 7A formed of a silicone-based resin is produced. Silicone-based resins are highly safe to the human body. Furthermore, the surface 7s of the shaped object 7A becomes soft, and a characteristic can be given to the tactile sensation.
(9) As the ink, one containing a platinum catalyst component can be used.

The liquid 6A can be a crosslinking agent having a hydrosilyl group.

When the ink and the liquid 6A are configured in this manner, the shaped object 7A formed of a silicone-based resin having high safety to the human body can be produced. Furthermore, the surface 7s of the shaped object 7A becomes soft, and a characteristic can be given to the tactile sensation.

The ink may contain a photoinitiator, and the liquid 6A may have a reactive group. In this case, the ultraviolet irradiating unit 4 irradiates the ultraviolet UV while the ink has landed on the liquid level 60 of the liquid 6A. Then, the ink is cured from the interface side between the ink and the liquid 6A. The curing speed at this time is faster than the case of using the epoxy resin, the acrylic resin, and the silicone resin described above. Therefore, the time required to produce the shaped object 7A can be shortened.
(10) As the ink, one containing a photoinitiator can be used.

As the liquid 6A, one containing a reactive group can be used.

The ink mixed with the liquid 6A is irradiated with ultraviolet UV from the ultraviolet irradiating unit 4, whereby the ink is cured.

According to such configuration of the ink and the liquid 6A, the ink can be quickly cured, and thus the time required to produce the shaped object 7A can be shortened.

### Modified Example 6

The shaped object producing method and the shaped object producing apparatus according to the present invention can also be applied to production of a shaped object 7B having a more complicated shape than the illustrated shaped object 7. Hereinafter, as Modified Example 6, a case of producing the humanoid shaped object 7B will be described as an example.

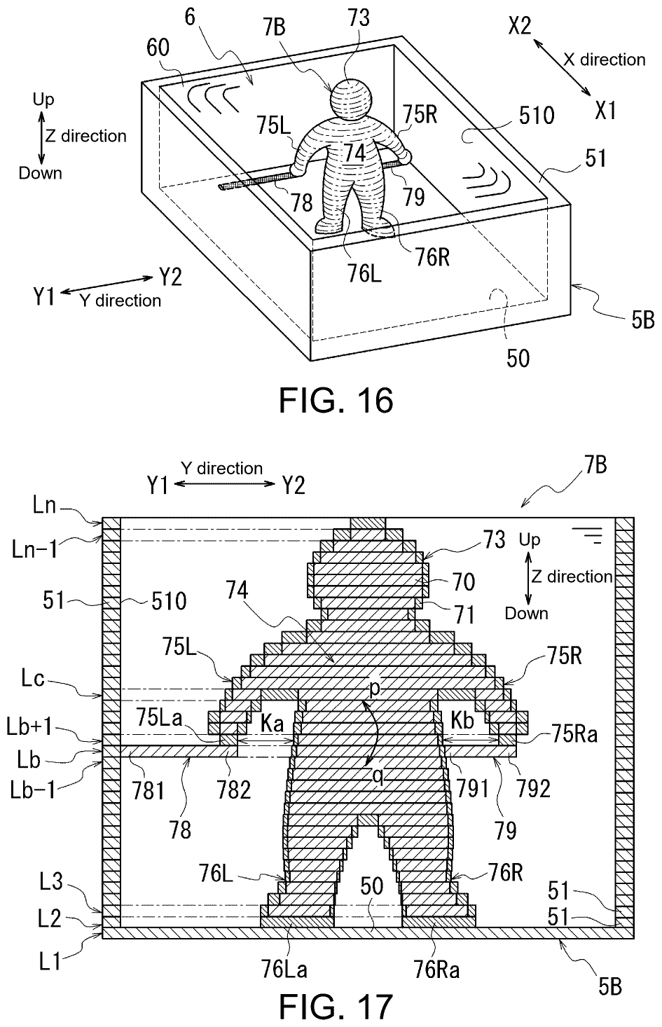

FIG. 16 is a perspective view illustrating the shaped object 7B according to Modified Example 6.

FIG. 17 is a view illustrating the slice data of the shaped object 7B according to Modified Example 6.

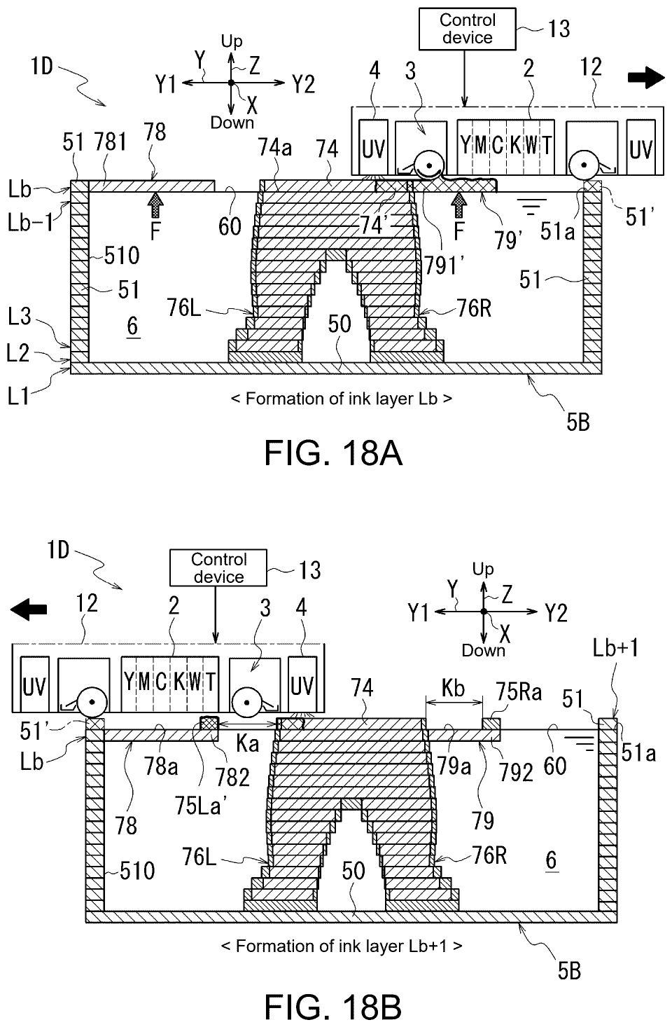

FIGS. 18A and 18B are views illustrating the method for producing the shaped object 7B according to Modified Example 6. FIG. 18A is a view illustrating the formation of the ink layer Lb. FIG. 18B is a view illustrating the formation of the ink layer Lb+1.

In Modified Example 6, a case where the shaping of the shaped object 7B and the shaping of the liquid storage unit 5B are performed in parallel using the producing apparatus 1D (see FIG. 11) will be described as an example.

As illustrated in FIG. 16, the humanoid shaped object 7B includes a head portion 73, a body portion 74 connected to a lower side of the head portion 73, a pair of arm portions 75L and 75R respectively extending from the body portion 74, and a pair of leg portions 76L and 76R. The pair of arm portions 75L and 75R is supported by the liquid storage unit 5B and the body portion 74 by holding portions 78 and 79 described later, respectively.

As illustrated in FIG. 17, the humanoid shaped object 7B also includes a solid portion 70 and a coloring portion 71 that covers the solid portion 70.

As illustrated in FIG. 16, in the liquid storage unit 5B, the head portion 73 of the shaped object 7B is located on the liquid level 60 side (upper side) in the Z direction, and the leg portions 76L and 76R are located on the bottom wall portion 50 side (lower side) in the Z direction. The arm portions 75L and 75R of the shaped object 7B are located on one side and the other side across the body portion 74 in the Y direction.

As illustrated in FIG. 17, the bottom wall portion 50 of the liquid storage unit 5B is formed in the ink layer L1. In the ink layer L2, the first peripheral wall portion 51 and lower end portions 76La and 76Ra of the leg portions 76L and 76R are formed. Hereinafter, inks constituting the first peripheral wall portion 51, the leg portions 76L and 76R, the body portion 74, the arm portions 75L and 75R, and the head portion 73 are sequentially laminated from the ink layer L3 to the ink layer Ln.

The body portion 74 and the head portion 73 overlap the leg portions 76L and 76R fixed to the bottom wall portion 50 in the Z direction. Therefore, in the laminating of the ink layers, the positional shift hardly occurs at the time of flattening by the roller unit 3.

The arm portions 75L and 75R overhang from the body portion 74 in the Y direction, and extend in a direction approaching the bottom wall portion 50 as separating from the body portion 74. The tip portions 75La and 75Ra of the arm portions 75L and 75R are positioned below the connecting portion with the body portion 74. The intervals between the body portion 74 and the tip portions 75La and 75Ra in the Y direction are set to Ka and Kb.

The ink layer Lb+1 on which the tip portions 75La and 75Ra of the arm portions 75L and 75R are formed is located on the lower layer side than the ink layer Lc on which the connecting portion with the body portion 74 is formed. Therefore, in the laminating of the ink layers, the arm portions 75L and 75R are formed from the tip portions 75La and 75Ra side. In the ink layer Lb+1, the body portion 74 and the tip portions 75La and 75Ra are formed at positions separated from each other in the Y direction.

Among the parts constituting the shaped object 7B, the arm portions 75L and 75R have the thinnest shapes. In particular, in the ink layer Lb+1, the ink constituting the tip portions 75La and 75Ra is ejected in a smaller amount than the ink constituting the head portion 73, the body portion 74, and the leg portions 76L and 76R, and the contact area with the liquid 6 is also small.

Therefore, the ink constituting the tip portions 75La and 75Ra cannot be held only by the viscosity of the liquid 6, and misalignment easily occurs at the time of flattening by the roller unit 3.

This may cause variations in the distances Ka and Kb between the body portion 74 and the tip portions 75La and 75Ra in the Y direction. The bite amount Δh (see FIG. 5A) of the roller 301 can be reduced so that the tip portions 75La and 75Ra do not move, but the number of paths increases and the shaping time becomes long.

Therefore, the shaped object 7B according to Modified Example 6 includes holding portions 78 and 79 that support the tip portions 75La and 75Ra of the arm portions 75L and 75R.

As illustrated in FIG. 17, the slice data of the shaped object 7B according to Modified Example 6 includes the shape data of the holding portions 78 and 79. The control device 13 controls the producing apparatus 1D based on the slice data of the shaped object 7B including the holding portions 78 and 79. Then, a region corresponding to the shaped object 7B and a region (holding region) corresponding to the holding portions 78 and 79 are formed.

As illustrated in FIG. 17, the holding portions 78 and 79 are formed in the ink layer Lb. The ink layer Lb is a lower layer of the ink layer Lb+1 in which the tip portions 75La and 75Ra are formed. The holding portions 78 and 79 are formed of white (W) ink, for example. The holding portions 78 and 79 are cut after producing the shaped object 7B.

The holding portion 78 is a pillar member extending in the direction along the Y direction and connecting the tip portion 75La of the arm portion 75L and the first peripheral wall portion 51. The holding portion 78 is connected to the inner peripheral surface 510 of the first peripheral wall portion 51 at one end portion 781 in the Y direction, and is connected to the tip portion 75La of the arm portion 75L at the other end portion 782.

The holding portion 79 is a pillar member extending in the direction along the Y direction and connecting the tip portion 75Ra of the arm portion 75R and the body portion 74. The holding portion 79 is connected to the body portion 74 at one end portion 791 in the Y direction and is connected to the tip portion 75Ra of the arm portion 75R at the other end portion 792.

As illustrated in FIG. 17, the inside of the liquid storage unit 5B has a region where the shaped object 7B is shaped and a region (holding region) where the holding portions 78 and 79 that support the shaped object 7B are formed.

Hereinafter, a method for producing the shaped object 7B by the producing apparatus 1D will be described. In the following description, the formation of the ink layers Lb and Lb+1 will be described as an example.

### Formation of Ink Layer Lb

As illustrated in FIG. 18A, the producing apparatus 1D ejects ink from the head unit 2 toward the upper surfaces 51a and 51a of the first peripheral wall portion 51, the upper surface 74a of the body portion 74, and the liquid level 60 in the ink layer Lb−1 while moving the carriage 12 in the Y2 direction according to the command of a control unit 13 (black arrow in the drawing).

In the ink layer Lb, the head unit 2 ejects the ink constituting each of the first peripheral wall portion 51, the holding portion 78, the body portion 74, the holding portion 79, and the first peripheral wall portion 51 in order in the Y2 direction.

In the ink ejecting process, the step of ejecting the ink constituting the holding portions 78 and 79 corresponds to the assisting step.

The producing apparatus 1D sequentially flattens the first peripheral wall portion 51, the holding portion 78, the body portion 74, the holding portion 79, and the first peripheral wall portion 51 with the roller unit 3 while moving the carriage 12 in the Y2 direction, and performs curing with the ultraviolet irradiating unit 4. Thereafter, the liquid 6 is supplied from the supply unit 8 (see FIG. 12).

In this case, one end portion 781 of the holding portion 78 is continuous from the first peripheral wall portion 51, and buoyancy F acts from the liquid level 60. Thus, even if flattening is performed by the roller unit 3, the holding portion 78 is held at a predetermined position on the liquid level 60.

In addition, in the holding portion 79, one end portion 791 is continuous from the body portion 74, and buoyancy F acts from the liquid level 60. Thus, even if flattening is performed by the roller unit 3, the holding portion 79 is held at a predetermined position on the liquid level 60.

The body portion 74 of the ink layer Lb is continuously laminated from the bottom wall portion 50 and the leg portions 76L and 76R formed on the lower layer side (the ink layer L1 to the ink layer Lb−1). Furthermore, the first peripheral wall portion 51 in the ink layer Lb is continuously laminated from the bottom wall portion 50 and the first peripheral wall portion 51 formed on the lower layer side (ink layer L1 to ink layer Lb−1). Therefore, even if the flattening is performed by the roller unit 3, the body portion 74 and the first peripheral wall portion 51 are held at predetermined positions.

### Formation of Ink Layer Lb+1

As illustrated in FIG. 18B, the producing apparatus 1D ejects the ink from the head unit 2 toward the upper surfaces 51a and 51a of the first peripheral wall portion 51, the upper surface 79a of the holding portion 79, the upper surface 74a of the body portion 74, and the upper surface 78a of the holding portion 78 in the ink layer Lb while moving the carriage 12 in the Y1 direction (black arrow in the drawing).

In the ink layer Lb+1, the head unit 2 sequentially ejects the ink constituting each of the first peripheral wall portion 51, the tip portion 75Ra, the body portion 74, the tip portion 75La, and the first peripheral wall portion 51 in the Y1 direction. In this case, the ink constituting the body portion 74 and the tip portions 75Ra and 75La is ejected to a plurality of regions (three locations) separated from each other in the Y direction.

The producing apparatus 1D sequentially flattens the first peripheral wall portion 51, the tip portion 75Ra, the body portion 74, the tip portion 75La, and the first peripheral wall portion 51 with the roller unit 3 while moving the carriage 12 in the Y1 direction, and performs curing with the ultraviolet irradiating unit 4. Thereafter, the liquid 6 is supplied from the supply unit 8 (see FIG. 12).

In this case, the ink constituting the tip portion 75Ra lands on the upper surface 79a on the other end portion 792 side of the holding portion 79. Therefore, the tip portion 75Ra is laminated on the holding portion 79. Furthermore, the ink constituting the tip portion 75La lands on the upper surface 78a on the other end portion 782 side of the holding portion 78. Therefore, the tip portion 75La is laminated on the holding portion 78. Therefore, the ink constituting the tip portions 75La and 75Ra is continuously laminated from the lower layer side (the ink layer L1 to the ink layer Lb).

As a result, the contact pressure applied to the tip portions 75La and 75Ra at the time of flattening can be received on the lower layer side via the holding portions 78 and 79, and the positions of the tip portions 75La and 75Ra are hardly displaced. Therefore, the distances Ka and Kb between the body portion 74 and the tip portions 75La and 75Ra in the Y direction hardly vary.

Thus, by further layering the ink layer on the tip portions 75La and 75Ra, the shaping accuracy of the entire arm portions 75L and 75R, which are overhang regions, of the shaped object 7B is improved.

Therefore, the distances Ka and Kb between the inks ejected to the plurality of regions (body portion 74 and tip portions 75La and 75Ra) separated in the Y direction can be reduced from varying without using a support material that covers the shaped object 7B.

The holding portions 78 and 79 are provided in a direction along the Y direction. Therefore, it is possible to resist the pressing force in the Y direction applied from the roller unit 3 to the tip portions 75La and 75Ra, and the rigidity at the time of shaping is increased to make it more difficult to vary.

In the shaped object 7B, the bending moment generated in the shaped object 7B at the time of flattening with the roller unit 3 (point of force) increases as the shaped object moves away from the bottom wall portion 50 (fulcrum) in the Z direction (for example, head 73). In this case, at the time of flattening, the shaped object 7B cannot be held only by the viscosity of the liquid 6, and the shaped object 7B may move or collapse in the liquid storage unit 5B.

Therefore, as illustrated in FIG. 17, the shaped object 7B is provided with a holding portion 78 that connects the tip portion 75La of the arm portion 75L and the inner peripheral surface 510 of the liquid storage unit 5B. Thus, when flattening the head 73 side, the bending moment generated in the shaped object 7B becomes a fulcrum with the holding portion 78 as a fulcrum (arrows p and q in FIG. 17). Since the distance between the fulcrum and the force point becomes short, the bending moment with the holding portion 78 as a fulcrum is smaller than the bending moment with the bottom wall portion 50 as a fulcrum. Therefore, the shaped object 7B can be reduced from moving or falling in the liquid storage unit 5B at the time of flattening.

As described above, the method for producing the shaped object 7B according to Modified Example 6 includes the following steps.
(i) The method for producing the shaped object 7A produces the shaped object 7A by repeating an ejecting step of ejecting the ink on the liquid 6 stored in the liquid storage unit 5B and a curing step of curing the ink ejected on the liquid 6 to form an ink layer and laminating the ink layers L1 to Ln.

The ejecting step includes:
an assisting step of forming the holding portions 78 and 79 (holding regions) that hold the ink ejected in the ejecting step.

The ink constituting the tip portions 75La and 75Ra of the arm portions 75L and 75R is ink ejected to a position away from the body portion 74 (cured ink).

The holding portions 78 and 79 hold the ink landing positions constituting the tip portions 75La and 75Ra of the arm portions 75L and 75R.

According to such producing, the distances Ka and Kb between the inks ejected to the plurality of regions (body portion 74 and tip portions 75La and 75Ra) separated in the Y direction can be reduced from varying. Therefore, the influence on the shaping quality of the shaped object 7B can be suppressed.
(ii) The holding portions 78 and 79 support the arm portions 75L and 75R, which are overhang regions in the shaped object 7B.

When produced in this manner, the shaping accuracy of the arm portions 75L and 75R is improved.
(iii) The method for ejecting the ink can be an inkjet method.

By layering the ink layers in the liquid 6, the surface quality and shaping accuracy of the surface of the coloring portion 1 of the shaped object 7 are improved than those covered with the support material. Therefore, by using the inkjet method, fine color expression and fine shaping expression, which are advantages of the inkjet method, can be utilized.
(iv) The holding portion 78 is connected to the inner peripheral surface 510 of the liquid storage unit 5B.

When produced in this manner, the bending moment generated in the shaped object 7B at the time of flattening can be reduced. Therefore, the shaped object 7B can be reduced from moving or falling in the liquid storage unit 5B.
(v) The holding portion 78 is connected to the first peripheral wall portion 51 of the liquid storage unit 5B.

The holding portion 79 is connected to the body portion 74.

The first peripheral wall portion 51 and the body portion 74 are cured inks.

According to such producing, the variation in the shaping position of the holding portions 78 and 79 themselves can be reduced. Therefore, the distances Ka and Kb between the inks ejected to the plurality of regions (body portion 74 and tip portions 75La and 75Ra) separated in the Y direction can be more suitably reduced from varying.
(vi) The assisting step is included in the ejecting step (ink layer Lb) one time before the ejecting step (ink layer Lb+1) of ejecting the ink constituting the tip portions 75La and 75Ra of the arm portions 75L and 75R.

When produced in this manner, in the formation of the ink layer Lb+1, the ink constituting the tip portions 75La and 75Ra of the arm portions 75L and 75R is held by being laminated on the holding portions 78 and 79 formed in the previous ejecting step (ink layer Lb). Therefore, the distances Ka and Kb between the inks ejected to the plurality of regions (body portion 74 and tip portions 75La and 75Ra) separated in the Y direction can be reduced from varying.

The producing apparatus 1D for the shaped object 7B according to Modified Example 6 has the following configuration.
(viii) The producing apparatus 1D for the shaped object 7B includes:
the liquid storage unit 5B that stores the liquid 6; and
the control unit 13 that controls ejecting of ink from the head unit 2 (ejecting unit) to the liquid 6 and curing of the ejected ink by the ultraviolet irradiating unit 4 (curing unit) is included.

The producing apparatus 1D for the shaped object 7B repeats the ejecting of the ink to the liquid 6 and the curing of the ink ejected to the liquid 6 to shape the shaped object 7B, which is a laminate of cured inks.

The ink constituting the tip portions 75La and 75Ra of the arm portions 75L and 75R is ink ejected to a position away from the body portion 74 (cured ink).

In the control unit 13, the holding portions 78 and 79 (holding regions) that hold the landing positions of the tip portions 75La and 75Ra of the arm portions 75L and 75R are formed by curing the ink ejected from the head unit 2.

According to such configuration, the distances Ka and Kb between the inks ejected to the plurality of regions (body portion 74 and tip portions 75La and 75Ra) separated in the Y direction can be reduced from varying. Therefore, the influence on the shaping quality of the shaped object 7B can be suppressed.
(ix) The control unit 13 connects the holding portion 78 to the inner peripheral surface 510 of the liquid storage unit 5B.

According to such configuration, the bending moment generated in the shaped object 7B at the time of flattening can be reduced. Therefore, the shaped object 7B can be reduced from moving or falling in the liquid storage unit 5B.
(x) The holding portion 78 is formed to be connected to the first peripheral wall portion 51 of the liquid storage unit 5B.

The holding portion 79 is formed to be connected to the body portion 74.

The first peripheral wall portion 51 and the body portion 74 are cured inks.

According to such configuration, the variation in the shaping position of the holding portions 78 and 79 themselves can be reduced. Therefore, the distances Ka and Kb between the inks ejected to the plurality of regions (body portion 74 and tip portions 75La and 75Ra) separated in the Y direction can be more suitably reduced from varying.
(xi) The head unit 2 can be an inkjet head.

By ejecting the ink from the inkjet head, fine color expression and fine shaping can be performed.

### Modified Example 7

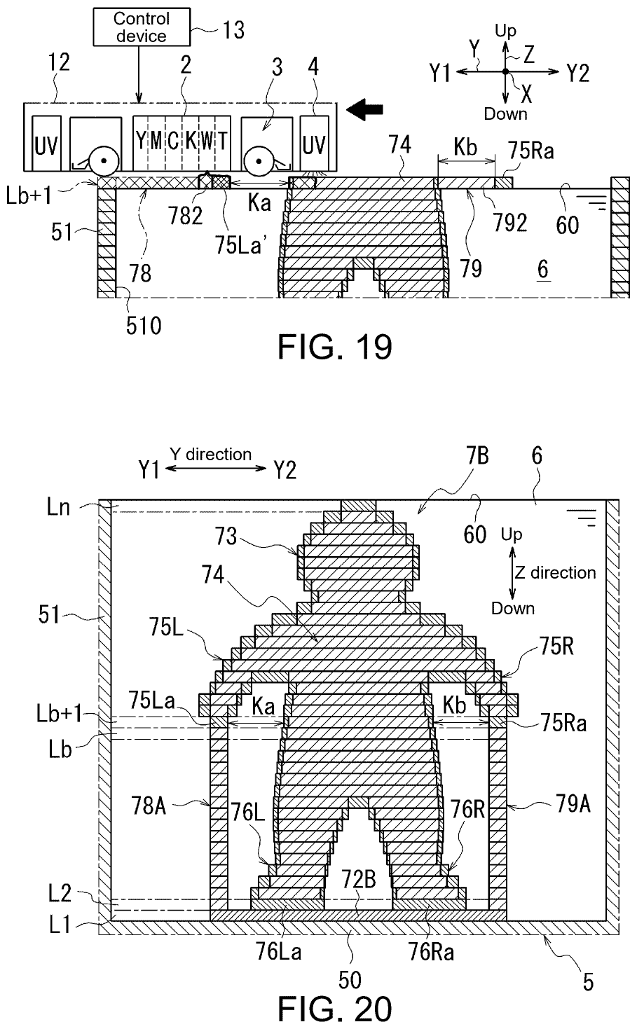

FIG. 19 is a view illustrating the method for producing the shaped object 7B according to Modified Example 7.

In Modified Example 6, the tip portions 78 and 79 of the arm portions 75La and 75Ra of the ink layer Lb+1 are laminated on the holding portions 75 and 75 formed in the ink layer Lb. However, the present invention is not limited to this aspect. As illustrated in FIG. 19, the holding portions 78 and 79 may be formed in the ink layer Lb+1, and the tip portions 78 and 79 may be connected to the other end portions 781 and 792 of the holding portions 75La and 75Ra, respectively.

In this case, in the formation of the ink layer Lb+1, the step of ejecting the ink of the tip portions 75La and 75Ra (ejecting step) includes the step of ejecting the ink of the holding portions 78 and 79 (assisting step).

As a result, the tip portion 75La is integrally formed with the holding portion 78 in the Y direction to be held. The tip portion 75Ra is held by being integrally formed with the holding portion 79 in the Y direction. The tip portions 75La and 75Ra are connected to the liquid storage unit 5B and the body portion 74 via the holding portions 78 and 79, respectively.

Therefore, the positions of the tip portions 75La and 75Ra are hardly displaced. Therefore, the distances Ka and Kb between the body portion 74 and the tip portions 75La and 75Ra in the Y direction hardly vary.

The method for producing the shaped object 7B according to Modified Example 7 has the following configuration.
(vii) The assisting step is included in the ejecting step (ink layer Lb+1) of ejecting the ink constituting the tip portions 75La and 75Ra of the arm portions 75L and 75R.

According to such configuration, the ink constituting the tip portions 75La and 75Ra of the arm portions 75L and 75R is held by being formed integrally with the holding portions 78 and 79, respectively. Therefore, the distances Ka and Kb between the inks ejected to the plurality of regions (body portion 74 and tip portions 75La and 75Ra) separated in the Y direction can be reduced from varying.

In Modified Examples 6 and 7, the holding portion 78 connects the arm portion 75L and the inner peripheral surface 510 of the liquid storage unit 5B, and the holding portion 79 connects the arm portion 75R and the body portion 74 (see FIGS. 16 to 19). However, the present invention is not limited to this aspect. The holding portions 78 and 79 may connect the arm portions 75L and 75R and the inner peripheral surface 510 of the liquid storage unit 5B, respectively. In addition, the holding portions 78 and 79 may connect the arm portions 75L and 75R and the body portion 74, respectively. The number of holding portions and the connection direction can be appropriately changed based on the weight, volume, and shape of the shaped object, the viscosity of the liquid 6, and the like.

### Modified Example 8

As illustrated in FIG. 20, the shaped object 7B may be produced in the liquid storage unit 5 filled with the liquid 6 in advance using the producing apparatus 1 (see FIGS. 1A and 1B).

FIG. 20 is a view illustrating the method for producing the shaped object 7B according to Modified Example 8.

As illustrated in FIG. 20, the shaped object 7B is provided on the ejecting base 72A. In the shaped object 7B, the lower end portions 76La and 76Ra of the leg portions 76L and 76R are connected to the ejecting base 72A.

The ejecting base 72A is provided in a range crossing the leg portions 76L and 76R in the Y direction and overlapping the tip portions 75La and 75Ra of the arm portions 75L and 75R.

The holding portions 78A and 79A are provided between the ejecting base 72A and the tip portions 75La and 75Ra of the arm portions 75L and 75R in the Z direction. The holding portions 78A and 79A are provided in a direction along the Z direction. The holding portions 78A and 79A may be formed of white (W) ink, or may be formed of the same ink as the ejecting base 72A.

In the method for producing the shaped object 7B according to Modified Example 8, first, the ejecting base 72A is formed as the ink layer L1. Next, as the ink layer L2, the holding portions 78A and 79A and the leg portions 76L and 76R are formed on the ejecting base 72A. Hereinafter, the ink layers are sequentially laminated up to the ink layer Ln.

As illustrated in FIG. 20, the holding portions 78A and 79A have areas substantially matching the tip portions 75La and 75Ra of the arm portions 75L and 76R in the Y direction. The holding portions 78A and 79A are laminated in a range of the ink layer L2 to the ink layer Lb.

Thus, in the formation of the ink layer Lb+1, the ink constituting the tip portions 75La and 75Ra lands on the upper surfaces of the holding portions 78A and 79A. The tip portions 75La and 75Ra are laminated on the holding portions 78A and 79A. Therefore, the ink constituting the tip portions 75La and 75Ra is continuously laminated from the lower layer side (the ink layer L1 to the ink layer Lb).

Thus, in the formation of the ink layer Lb+1, the contact pressure applied to the tip portions 75La and 75Ra at the time of flattening can be received on the lower layer side via the holding portions 78A and 79A, and the positions of the tip portions 75La and 75Ra are less likely to deviate. Therefore, the distances Ka and Kb between the body portion 74 and the tip portions 75La and 75Ra in the Y direction are reduced from varying.

In the above-described embodiment and modified examples, the case where the head unit 2 is an inkjet head has been exemplified, but the present invention is not limited to this aspect. For example, the head unit 2 may be a dispenser, a spray gun, or the like.

As described above, the embodiment and the modified examples of the present invention have been described. The present invention is not limited only to the aspects of these embodiments and modified examples. The above-described embodiment and modified examples may be arbitrarily combined.

Although the embodiment of the present invention has been described above, the above-described embodiment merely shows one application example of the present invention, and the technical scope of the present invention is not intended to be limited to the specific configuration of the above-described embodiment. Modifications can be made as appropriate within the scope of the technical idea of the invention.

1. A shaped object producing method for shaping a three-dimensional shaped object, comprising:
an ejecting step of ejecting ink to a liquid stored in a liquid storage unit; and
a curing step of curing the ink ejected into the liquid.

2. The shaped object producing method according to claim 1, comprising:
a laminating step of laminating ink layers in the liquid by repeating the ejecting step and the curing step.

3. The shaped object producing method according to claim 2, comprising:
a discharging step of discharging the liquid of the same volume as the ink layer whenever the ink layer is formed.

4. The shaped object producing method according to claim 2, comprising:
a supplying step of supplying the liquid having a height equal to a thickness of the ink layer whenever the ink layer is formed.

5. The shaped object producing method according to claim 1,
wherein the ink is an ultraviolet curable ink.

6. The shaped object producing method according to claim 1,
wherein the ink contains a material serving as a main agent, the liquid contains a material serving as a curing agent, and the ink is cured by mixing the liquid with the ink.

7. The shaped object producing method according to claim 6,
wherein the ink contains a metal catalyst component, and
wherein the liquid contains a peroxide component.

8. The shaped object producing method according to claim 6,
wherein the ink is an epoxy resin, and
wherein the liquid is an amine curing agent.

9. The shaped object producing method according to claim 6,
wherein the ink contains a platinum catalyst component, and
wherein the liquid is a crosslinking agent having a hydrosilyl group.

10. The shaped object producing method according to claim 6,
wherein the ink contains a photoinitiator,
wherein the liquid contains a reactive group, and
wherein the ink mixed with the liquid is irradiated with ultraviolet light to cure the ink.

11. The shaped object producing method according to claim 1,
wherein the ink is a thermosetting ink.

12. The shaped object producing method according to claim 1,
wherein the ink is a thermoplastic ink.

13. The shaped object producing method according to claim 1,
wherein the method of ejecting the ink is an inkjet method.

14. A shaped object producing apparatus for shaping a three-dimensional shaped object, the shaped object producing apparatus comprising:
a liquid storage unit that holds a liquid;
an ejecting unit that ejects ink to the liquid; and
a curing unit that cures the ink ejected into the liquid.

15. The shaped object producing apparatus according to claim 14, comprising:
a recovery unit that recovers the liquid overflowing from the liquid storage unit.

16. The shaped object producing apparatus according to claim 14,
wherein the liquid storage unit has a recess in which an upper surface of a table provided below the ejecting unit is opened, and the liquid is stored in the recess.

17. The shaped object producing apparatus according to claim 14, comprising:
a vibration suppression mechanism that suppresses vibration of the liquid storage unit.

18. The shaped object producing apparatus according to claim 14,
wherein the ejecting unit is an inkjet head.

19. A shaped object producing method for shaping a three-dimensional shaped object, comprising:
an ejecting step of ejecting ink to a liquid stored in a liquid storage unit; and
a curing step of curing the ink ejected to the liquid,
wherein the ink is formed of a composition having a specific gravity before curing lighter than the liquid and a specific gravity after curing heavier than the liquid.

20. The shaped object producing method according to claim 19,
wherein the ink before curing has a viscosity of 15 mPa·s or more and 30 mPa·s or less.

21-36. (canceled)
